(19) United States
(12) Patent Application Publication
(10) Pub. No.: US 2018/0328745 A1
(43) Pub. Date: Nov. 15, 2018

(54) COVERAGE PLAN GENERATION AND IMPLEMENTATION

(71) Applicant: Uber Technologies, Inc., San Francisco, CA (US)

(72) Inventors: Bryan Nagy, Pittsburgh, PA (US); Anthony Stentz, Pittsburgh, PA (US); Xiaodong Zhang, Pittsburgh, PA (US)

(21) Appl. No.: 15/973,720

(22) Filed: May 8, 2018

Related U.S. Application Data
(60) Provisional application No. 62/503,790, filed on May 9, 2017.

(51) Int. Cl. G01C 21/32; G05D 1/00; G05D 1/02

(52) U.S. Cl. CPC G01C 21/32; G05D 1/0212; G05D 1/0088

(57) ABSTRACT

Systems and methods can generate and/or implement coverage plans for vehicle navigation. Such coverage plans can be descriptive of a travel route for a vehicle to navigate a set of travel way portions within a map of a geographic area. The coverage plan can include a travel route that traverses each travel way portion at least once while reducing total travel cost (e.g., defined by a travel distance, number and/or types of turns, etc.) over all travel way portions. The coverage plan can also reduce turn angles and/or eliminate u-turns in order to provide a coverage plan that is safer and easier for implementation by vehicles controlled to navigate along the travel route.

### CROSS-REFERENCE TO RELATED APPLICATION

This application claims the benefit of priority to U.S. Provisional Application No. 62/503,790 entitled “Coverage Plan Generation and Implementations,” filed on May 9, 2017; which is hereby incorporated by reference in its entirety.

### FIELD

The present disclosure generally relates to generating and implementing coverage plans for navigating and mapping travel way portions within a geographic area.

### BACKGROUND

Map data can include a large amount of information about roads or other travel ways in a particular geographic area. For example, map data can provide information regarding the identity and general location of different travel ways. However, map data does not always include specific information about each travel way, such as information about particular lanes and connectivity within a travel way, directions of traffic flow, identification of traffic control devices, etc. In addition, map data is not always updated to reflect changing availability of different travel ways.

Map data can be used for a variety of different vehicle applications. For example, map data can be used to help determine travel routes for navigating vehicles within a given geographic area. Such travel routes can be especially useful for autonomous vehicles that are capable of sensing their environment and navigating along a travel route without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path relative to a travel route through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a vehicle computing system for implementing a coverage plan. The vehicle computing system includes one or more processors on-board a vehicle and one or more memory devices on-board the vehicle. The one or more memory devices store instructions that when executed by the one or more processors cause the computing system to perform operations. The operations include obtaining a coverage plan descriptive of a travel route for the vehicle to navigate a set of travel way portions within a map of a geographic area. The operations also include controlling the vehicle to navigate along the travel route described by the coverage plan. The operations also include gathering sensor data from one or more sensors provided within the vehicle as it is controlled to navigate the travel route. The operations also include constructing a vehicle navigation map including travel way portions and intersections based at least in part on the sensor data gathered from the one or more sensors.

Another example aspect of the present disclosure is directed to a computer-implemented method of implementing a coverage plan. The method includes transforming, by one or more computing devices, map data identifying travel way portions into a coverage graph of nodes and edges. Each edge represents a travel way portion and each node represents an intersection or connection between adjacent travel way portions. The method also includes determining, by the one or more computing devices, a coverage plan descriptive of a travel route along edges in the coverage graph. The travel route traverses each edge in the coverage graph at least once while reducing total travel cost over all edges and while reducing turn angles such that the travel route prefers an outgoing edge from a given node that reduces the angle difference between an incoming edge and each outgoing edge. The method also includes controlling, by the one or more computing devices, a vehicle to navigate along the travel route described by the coverage plan.

A still further example aspect of the present disclosure is directed to one or more tangible, non-transitory computer-readable media storing computer-readable instructions that when executed by one or more processors cause the one or more processors to perform operations. The operations include obtaining a coverage plan descriptive of a travel route for a vehicle to navigate a set of travel way portions within a map of a geographic area. The travel route described by the coverage plan includes all travel way portions in the set of travel way portions at least once while reducing total travel cost over all travel way portions. The operations also include controlling the vehicle to navigate along the travel route described by the coverage plan. The operations also include gathering sensor data from one or more sensors provided within the vehicle as the vehicle is controlled to navigate the travel route.

Other example aspects of the present disclosure are directed to systems, methods, vehicles, apparatuses, tangible, non-transitory computer-readable media, user interfaces, and memory devices for generating and/or implementing navigational coverage plans.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for controlling the navigation of a vehicle according to example embodiments of the present disclosure;

FIG. 2 depicts an example system for implementing coverage plans according to example embodiments of the present disclosure;

FIG. 3 depicts a first example portion of map data according to example embodiments of the present disclosure;

FIG. 4 depicts a first example coverage graph of nodes and edges transformed from the map data of FIG. 3 according to example embodiments of the present disclosure;

FIG. 5 depicts a second example portion of map data according to example embodiments of the present disclosure;

FIG. 6 depicts a second example coverage graph of nodes and edges transformed from the map data of FIG. 5 according to example embodiments of the present disclosure;

FIG. 7-8 depict a first example aspect of generating a coverage plan according to example embodiments of the present disclosure;

FIGS. 9-11 depict a second example aspect of generating a coverage plan according to example embodiments of the present disclosure;

FIG. 12 depicts a third example aspect of generating a coverage plan according to example embodiments of the present disclosure;

FIG. 13 depicts a fourth example aspect of generating a coverage plan according to example embodiments of the present disclosure;

FIGS. 14-15 depict a fifth example aspect of generating a coverage plan according to example embodiments of the present disclosure;

FIGS. 16-17 depict a sixth example aspect of generating a coverage plan according to example embodiments of the present disclosure;

FIGS. 18-21 depict a seventh example aspect of generating a coverage plan according to example embodiments of the present disclosure;

FIG. 22 depicts a flow chart of an example method for implementing a coverage plan according to example embodiments of the present disclosure;

FIG. 23 depicts a flow chart of an example method for addressing deviations from a coverage plan according to example embodiments of the present disclosure; and

FIG. 24 depicts a flow chart of an example method for generating a coverage plan according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to systems and methods that generate and implement coverage plans. In particular, the systems and methods of the present disclosure can generate or otherwise obtain a coverage plan descriptive of a travel route for a vehicle to navigate a set of travel way portions within a map of a geographic area. The coverage plan can include a travel route that traverses each travel way portion at least once while reducing total travel cost (e.g., defined by a travel distance, number and/or types of turns, etc.) over all travel way portions. The initial coverage plan can also reduce turn angles and/or eliminate u-turns in order to provide a coverage plan that is safer and easier for implementation by vehicles controlled to navigate along the initial travel route. Sensor data then can be gathered from one or more sensors (e.g., location sensors, position sensors, image sensors, etc.) as a vehicle is controlled to navigate a travel route provided within a coverage plan. This gathered sensor data then can be used to construct a detailed vehicle navigation map of the geographic area, validate the accuracy and/or connectivity of map data and/or determined travel routes, determine viability of travel routes through actual navigation with and/or without traffic, and/or generate one or more repeatable test paths for vehicle operation.

More particularly, a coverage plan can be generated or otherwise obtained by one or more vehicle computing devices and/or by one or more remote computing devices. The one or more computing devices can access map data identifying travel way portions (e.g., roads, road segments, lanes, lane segments, parking lanes, turning lanes, bicycle lanes, and/or other portions of a particular travel way) and/or intersections and/or connections among adjacent travel way portions within a given geographic area intended for vehicle navigation. The one or more computing devices can also obtain a set of coverage bounds descriptive of those travel way portions to be included and optionally excluded in a coverage plan. In some implementations, coverage bounds can include polygons drawn using a graphical interface tool or other geographic identifiers for identifying travel way portions that should be included or optionally excluded. Map data can be evaluated relative to the coverage bounds to determine which travel way portions are required, permitted and/or forbidden for vehicle navigation within the travel route.

The one or more computing devices can transform the map data including required travel way portions (and optionally permitted travel way portions) into a coverage graph of nodes and edges. Each edge in the coverage graph can represent a travel way portion, while each node in the coverage graph can represent an intersection or connection among adjacent travel way portions. In some implementations, the coverage graph of nodes and edges can be configured to be strongly connected such that an edge is provided in both directions between each pair of connected nodes in the coverage graph. In other words, a strongly connected coverage graph can include all nodes that are reachable from a start node and from which the start node is also reachable.

The coverage graph of nodes and edges can be enhanced in one or more ways before being using to determine an initial coverage plan. For example, Eulerian balancing can be employed to generate additional artificial edges between unbalanced nodes that do not have an equal number of incoming edges and outgoing edges. In order to determine which nodes are unbalanced, an edge count can be determined at each node. The edge count can correspond to the number of incoming edges for a given node minus the number of outgoing edges for that node. A node characterized by a positive edge count corresponds to a node having one or more extra incoming edges, while a node characterized by a negative edge count corresponds to a node having one or more extra outgoing edges. For each node having a non-zero edge count (e.g., +1, −1, +2, −2, etc.), additional artificial edges can be generated between that node and another node having a non-zero edge count. In some implementations, additional artificial edges can be generated from a node having a positive edge count to a node having a negative edge count. If a node has N unbalanced edges, then N additional artificial edges can be added into or out of that node.

In some implementations, a matching algorithm can be employed to determine a preferred path for the additional artificial edges generated in the Eulerian balancing process. In some examples, a bipartite matching algorithm can be employed, although other matching algorithms are also possible. A matching algorithm can be especially useful when a coverage graph contains more than one unique unbalanced node having a positive edge count and more than one unique unbalanced node having a negative edge count. An enhanced coverage graph can correspond to a coverage graph that is balanced using the described Eulerian balancing and/or bipartite matching enhancement algorithms.

A computing device can then determine a coverage plan descriptive of a travel route along edges in an optionally enhanced graph. For example, a travel route can be determined that traverses each edge in the coverage graph at least once while reducing total travel cost over all edges. In some implementations, the travel route can be determined by determining an Eulerian path among nodes and edges in the graph. In some implementations, the Eulerian path traverses each edge in the coverage graph only once.

In particular implementations, determining an Eulerian path can include determining a main path as well as one or more sub-paths, if needed, which can be spliced into the main path. Determining a main path can include identifying a start node and traversing consecutive edges within the coverage graph from the identified start node until reaching the identified start node again. Nodes within the main path then can be checked to identify any remaining nodes having unvisited exits (e.g., outgoing edges not yet traversed as part of the main path). Each such identified remaining node can then form a subsequent starting node for a new sub-path from the remaining node along consecutive edges within the coverage graph not yet visited until returning to the remaining node. Upon completion of each sub-path, the sub-path can then be spliced into the main path between the remaining node and its original successor in the main path. The process of creating new sub-paths and splicing those sub-paths into the main path is repeated until all exits for all nodes within the coverage graph have been visited.

In particular implementations, determining an Eulerian path can include selecting outgoing edges within a main path and/or sub-path that reduce turns (e.g., a total number of turns and/or a total value of angle difference associated with turns) within the path. For example, when a path follows an incoming edge and reaches a node having multiple outgoing edges, an outgoing edge can be selected that reduces the angle difference between the incoming edge and each outgoing edge. In some implementations, u-turns can be minimized by reducing selection of an outgoing edge that has an angle difference of 180 degrees from a corresponding incoming edge. In some implementations, outgoing edges that travel straight (e.g., have an angle difference as close to zero degrees as possible) relative to an incoming edge can be preferred over outgoing edges that turn (e.g., have a larger non-zero angle difference) relative to an incoming edge.

In some implementations, reducing turns within a travel route and/or path can include identifying a u-turn between a first node and a second node in a travel route, determining an alternate path between the first node and the second node, and replacing the u-turn between the first node and the second node with the alternate path. In some implementations, a u-turn can be replaced with an alternate path when a cost associated with the alternate path is below a given threshold and/or below a cost associated with the u-turn.

In some implementations, reducing turns within a travel route and/or path can include identifying bounded u-turns located at a boundary point of a coverage plan (e.g., nodes and/or edges located along the periphery of a graph). In some instances, a bounded u-turn may appear to exist between a first node and a second node in the ordinary course of an Eulerian path, but could be avoided if a coverage graph were to include additional artificial edges corresponding to travel way portions outside an initial coverage plan. In such instances, each first node associated with a bounded u-turn can be split into two unbalanced first nodes, and each second node associated with a bounded u-turn can be split into two unbalanced second nodes. A sub-path can then be determined that includes the unbalanced first nodes, the unbalanced second nodes and one or more additional nodes added to the coverage graph from an area outside the initial coverage plan. The determined sub-path can then be spliced into the previously determined Eulerian path to create an improved travel route with reduced u-turns.

In some implementations, action items can be implemented as needed to address potential changes and/or navigational issues. For example, a vehicle could make a wrong turn while following a travel route, or initial map data for a given geographic area could be incorrect or could change over time. In such instances, a vehicle may be unable to proceed along a travel route defined by the coverage plan. In such instances, a deviation of the vehicle from the travel route can be detected. An update descriptive of a reason for the deviation from the travel route can be transmitted from the vehicle to another computing device remote from the vehicle. Revised navigation instructions can be determined that return the vehicle to the last unvisited permitted travel way portion within the travel route. The vehicle can be controlled according to the revised navigation instructions. In certain variations, the vehicle may determine an updated travel route autonomously using on-board computing systems, and can determine the revised navigation instructions independently.

Computing devices can use the disclosed systems and methods for implementing coverage plans for navigation of a vehicle along the travel routes described by the coverage plans. In some implementations, vehicles can be manually navigated in accordance with the disclosed coverage plans. For example, a vehicle provided with a computing system including mapping components can be navigated in accordance with the disclosed coverage plans. In other implementations, autonomous vehicles with a computing system including mapping components and/or autonomy components can be manually driven and/or controlled in accordance with the disclosed coverage plans. A vehicle can be a ground-based vehicle (e.g., car, truck, bus), air-based vehicle (e.g., airplane, drone, helicopter, or other aircraft), or other type of vehicle (e.g., watercraft). In some implementations, the disclosed systems and methods can be implemented by an autonomous vehicle that is associated with an entity (e.g., a service provider) that provides one or more vehicle service(s) to a plurality of users via a fleet of vehicles that includes, for example, the autonomous vehicle. The vehicle service(s) can include transportation services (e.g., rideshare services), courier services, delivery services, and/or other types of services. The vehicle service(s) can transport and/or deliver passengers as well as items such as but not limited to food, animals, freight, purchased goods, etc.

When autonomous vehicles are utilized, such autonomous vehicles can be configured to drive, navigate, operate, etc. with minimal and/or no interaction from a human driver. For example, an autonomous vehicle can be configured to operate in one or more mode(s) such as, for example, a fully autonomous operational mode and/or a semi-autonomous operational mode. A fully autonomous (e.g., self-driving) operational mode can be one in which the autonomous vehicle can provide driving and navigational operation with no interaction from a human driver. A semi-autonomous operational mode can be one in which the autonomous vehicle can operate with some interaction from a human driver present in the vehicle. In some implementations, mapping components within an autonomous vehicle can be used to navigate such a vehicle along one or more travel routes described within the disclosed coverage plans, with or without use of additional autonomy components provided within the vehicle.

A vehicle implementing the disclosed coverage plans can sometimes include one or more sensors (e.g., a positioning system for determining a current geographic location of the vehicle and/or object detection sensors). A positioning system can be any device or circuitry for analyzing the position of the vehicle. For example, the positioning system can determine actual or relative position by using a satellite navigation positioning system (e.g., a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position). Object detection sensors can include, for example, a Light Detection and Ranging (LIDAR) system, a Radio Detection and Ranging (RADAR) system, one or more cameras or other image capture devices, and/or other sensors. The sensors can be used to gather additional data as a vehicle traverses the routes provided within the coverage plans and/or additional vehicle navigation maps that are generated based on the coverage plans.

Gathered vehicle sensor data can be used in a variety of manners. For example, the position of the vehicle and/or other sensor data can be compared with the map data used to generate the coverage plans or with the coverage plan data itself to verify the accuracy of such data. The sensor data can alternatively be added to existing map data to provide more detailed information regarding a geographic area. Such data can be used, for example, to construct a vehicle navigation map based at least in part on the sensor data gathered from the one or more sensors. A vehicle navigation map can include, for instance, a plurality of travel way portions and intersections between adjacent travel way portions as traveled by the vehicle along a travel route. In some implementations, a vehicle can subsequently be controlled to navigate along a travel route within the vehicle navigation map that includes every travel way within the coverage map at least once and every turn at each intersection in the coverage map at least once.

A vehicle implementing the disclosed coverage plans can include a vehicle computing system including one or more computing devices. The vehicle computing system can analyze geographic location data from a vehicle positioning system to track a vehicle as it navigates along a travel route, detect deviations from travel routes and determine revised navigation instructions. When a vehicle is an autonomous vehicle, the vehicle computing system can also determine a motion plan to control motion of a vehicle along a determined travel route. The motion plan can be further based on any objects proximate to the autonomous vehicle (e.g., pedestrians, other vehicles, traffic control devices, etc.) that are detected by the one or more sensors. The vehicle computing system can include various sub-systems that cooperate to perceive the surrounding environment of the autonomous vehicle and determine a motion plan for controlling the motion of the autonomous vehicle along a travel route. For instance, the vehicle computing system can include a perception system, a prediction system, and a motion planning system. A mobility controller then can receive motion plans from the vehicle computing system and translate the motion plan into control signals for vehicle controls (e.g., steering, braking, throttle, etc.)

A vehicle implementing the disclosed coverage plans can further include one or more communication interfaces for transmitting/receiving map data and/or coverage plan data (e.g., including travel routes) and/or vehicle deviation detections from the vehicle to another computing device remote from the vehicle. For instance, coverage plans and/or travel routes and/or updates can be transmitted from a given vehicle to one or more different vehicles and/or to a remote computing device associated with central control system associated with a service provider, owner, and/or fleet operator in communication with a fleet of vehicles. In some implementations, an update descriptive of a reason for deviation of a vehicle from a travel route (e.g., construction, map error, etc.) can be transmitted upon detection of a deviation from a travel route.

The systems, methods, and vehicles described herein may provide a number of technical effects and benefits. For instance, in some implementations, an enhanced coverage plan descriptive of a travel route for a vehicle can be generated or otherwise provided. Such a coverage plan can advantageously include all travel way portions in a set of travel way portions at least once while reducing total travel cost over all travel way portions. In some implementations, coverage plans can also advantageously reduce turns (e.g., a total number of turns and/or a total value of angle difference associated with turns) within a given travel route. In some implementations, coverage plans can also advantageously reduce and/or eliminate u-turns including bounded u-turns along the periphery of a coverage plan. Reducing turns within a travel route, especially u-turns, can provide a coverage plan that is safer and easier for vehicle implementation, especially for use by autonomous vehicles.

The systems, methods, and vehicles described herein can have an additional technical effect and benefit of facilitating dynamic determination of revised navigation instructions for navigating a travel route when unexpected interruptions or deviations in navigation occur during vehicle navigation. More particularly, in some implementations, a vehicle may encounter an instance where it is unable or prefers not to follow a travel route described by a coverage plan because of potential navigational issues. For example, a vehicle could make a wrong turn while following a travel route. In another example, initial map data for a given geographic area could be incorrect or could change over time. In a still further example, dynamically changing events such as a traffic accident, construction, or street fair can affect a vehicle's ability to navigate along a travel route. In such instances, a vehicle computing system can be equipped with a coverage plan application that can accommodate determination of revised navigation instructions for returning the vehicle to the last unvisited permitted travel way portion within a travel route when implementation of an initial travel route is compromised.

The systems, methods, and vehicles described herein have an additional technical effect and benefit of providing a scalable approach to implementing coverage plans. In some examples, a vehicle computing system can obtain initial coverage plans from a remote computing system associated with central control system associated with a service provider, owner, and/or fleet operator in communication with a fleet of vehicles. Fleet operators or other entities have the flexibility of sending instructions to an entire fleet of vehicles operating in a given geographic area, to just one vehicle, or to a subset of vehicles. Coverage plans can be customized based on the vehicle and/or its location in order to account for travel way design, operational parameters, events, etc. that are different from city to city, country to country or the like. Conversely, detected deviations in a travel route described by a coverage plan as well as encountered reasons for those deviations can be determined locally by a vehicle computing system with or without additional manual input and can then be sent back to a remote computing device and/or to one or more other vehicle computing systems associated with different vehicles. As such, travel plans can be customized per vehicle or fleet, while needed revisions to travel routes and coverage plans based on encountered deviations can be updated and shared as needed in order to provide communicated improvements and flexibility in controlling navigation.

The systems, methods, and vehicles described herein can have an additional technical effect and benefit of providing an improvement to vehicle computing technology. For instance, aspects of the present disclosure enable a vehicle computing system to more efficiently and accurately control the vehicle's motion along a travel route. By determining revised navigation instructions for implementing coverage plans locally (e.g., on-board the vehicle) when needed, a vehicle computing system can avoid certain latency issues that arise by reliance on a remote computing system for off-board operations. The vehicle computing system can be configured to detect deviations from a travel route and determine revised navigation instructions for returning a vehicle to the last unvisited permitted travel way portion within a travel route as opposed to waiting for revised travel routes to be approved or disapproved by a central command system or other remote computing device/system. As such, travel routes can be revised and/or implemented as needed with increased computational efficiency.

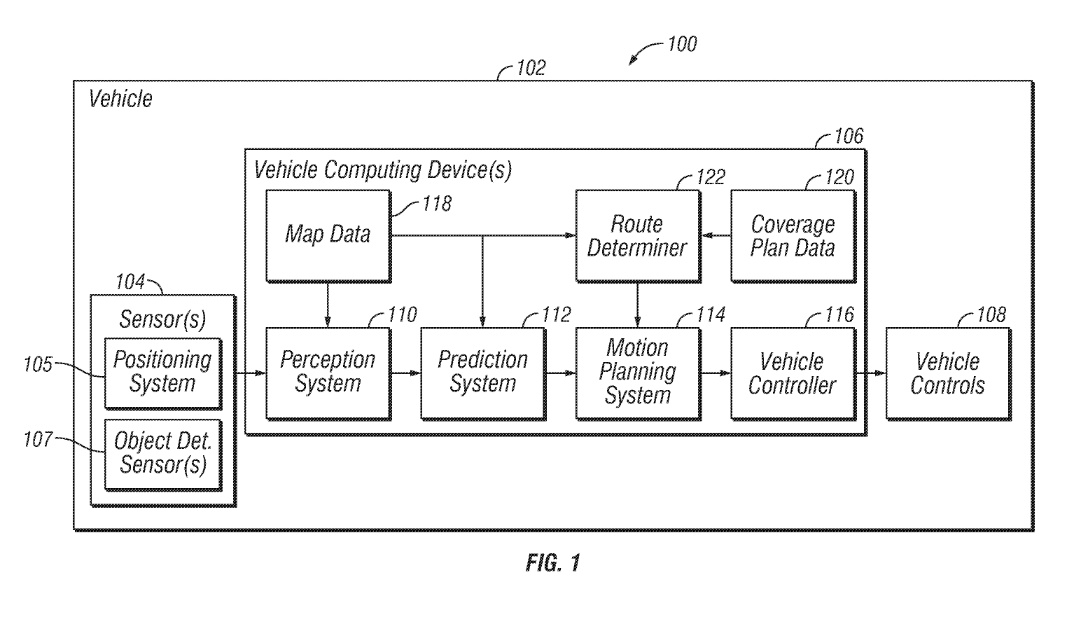

With reference now to the Figures, example embodiments of the present disclosure will be discussed in further detail. FIG. 1 depicts an example vehicle computing system 100 associated with a vehicle 102 according to example embodiments of the present disclosure. The vehicle 102 incorporating the vehicle computing system 100 can be a ground-based vehicle (e.g., car, truck, bus), an air-based vehicle (e.g., airplane, drone, helicopter, or other aircraft), or other type of vehicle (e.g., watercraft). In some implementations, vehicle 102 can be manually navigated in accordance with the disclosed coverage plans. In other implementations, vehicle 102 can be an autonomous vehicle configured to drive, navigate, operate, etc. with minimal and/or no interaction from a human driver. For example, when vehicle 102 is an autonomous vehicle, vehicle 102 can be configured to operate in one or more mode(s) such as, for example, a fully autonomous operational mode and/or a semi-autonomous operational mode. A fully autonomous (e.g., self-driving) operational mode can be one in which the vehicle 102 can provide driving and navigational operation with no interaction from a human driver. A semi-autonomous operational mode can be one in which the vehicle 102 can operate with some interaction from a human driver present in the vehicle 102. In some implementations, the vehicle 102 can be associated with an entity (e.g., a service provider) that provides one or more vehicle service(s) to a plurality of users via a fleet of vehicles that includes, for example, the vehicle 102. The vehicle service(s) can include transportation services (e.g., rideshare services), courier services, delivery services, and/or other types of services. The vehicle service(s) can transport and/or deliver passengers as well as items such as but not limited to food, animals, freight, purchased goods, etc.

As further illustrated in FIG. 1, the vehicle computing system 100 can include one or more sensors 104, one or more vehicle computing devices 106 and one or more vehicle controls 108. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The on-board systems can send and/or receive data, messages, signals, etc. amongst one another via the communication channel.

The one or more sensors 104 can include, for example, a positioning system 105 for determining a current geographic location of the vehicle 102 and/or one or more object detection sensors 107. Positioning system 105 can be any device or circuitry for analyzing the position of the vehicle 102. For example, the positioning system 105 can determine actual or relative position of vehicle 102 by using a satellite navigation positioning system (e.g., a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position). Object detection sensors 107 can include, for example, a Light Detection and Ranging (LIDAR) system, a Radio Detection and Ranging (RADAR) system, one or more cameras (e.g., visible spectrum cameras, infrared cameras, etc.) or other image capture devices, and/or other sensors. Sensor data from object detection sensors 107 can include information that describes the location (e.g., in three-dimensional space relative to the vehicle 102) of points that correspond to objects within the surrounding environment of the vehicle 102 (e.g., at one or more times).

In some implementations, the sensors 104 can be used to facilitate navigation of vehicle 102 when vehicle 102 is operating in an autonomous mode. In some implementations, the sensors 104 can be used to gather additional data as vehicle 102 traverses routes provided within the disclosed coverage plans and/or additional coverage maps that are generated based on the coverage plans.

The one or more computing devices 106 can include various components, some of which can be optional for implementation of the disclosed coverage plans. For example, the perception system 110, prediction system 112 and one or more portions of the motion planning system 114 may be included within the one or more computing devices 106 when vehicle 102 is an autonomous vehicle. When included, the perception system 110, prediction system 112, and motion planning system 114 can cooperate to perceive the surrounding environment of the vehicle 102 and determine a motion plan for controlling the motion of vehicle 102 accordingly. In particular, in some implementations, the perception system 110 can receive sensor data from the one or more sensors 104 that are coupled to or otherwise included within the vehicle 102.

As one example, for a LIDAR system, the sensor data from object detection sensor(s) 107 can include the location (e.g., in three-dimensional space relative to the LIDAR system) of a number of points that correspond to objects that have reflected a ranging laser. For example, a LIDAR system can measure distances by measuring the Time of Flight (TOF) that it takes a short laser pulse to travel from the sensor to an object and back, calculating the distance from the known speed of light.

As another example, for a RADAR system, the sensor data from object detection sensor(s) 107 can include the location (e.g., in three-dimensional space relative to the RADAR system) of a number of points that correspond to objects that have reflected a ranging radio wave. For example, radio waves (pulsed or continuous) transmitted by the RADAR system can reflect off an object and return to a receiver of the RADAR system, giving information about the object's location and speed. Thus, a RADAR system can provide useful information about the current speed of an object.

As yet another example, for one or more cameras, various processing techniques (e.g., range imaging techniques such as, for example, structure from motion, structured light, stereo triangulation, and/or other techniques) can be performed to identify the location (e.g., in three-dimensional space relative to the one or more cameras) of a number of points that correspond to objects that are depicted in imagery captured by the one or more cameras. Other sensor systems can identify the location of points that correspond to objects as well.

In addition to the sensor data, the computing device(s) 106 can retrieve or otherwise obtain map data 118 that provides detailed information about the surrounding environment of the vehicle 102. The map data can provide information regarding the identity and location of different travel ways (e.g., roads, road segments, lanes, lane segments, parking lanes, turning lanes, bicycle lanes, or other portions of a particular travel way). In some examples, travel way portions within map data 118 can include one or more descriptors including, for example, a travel way portion identifier, a start point for the travel way portion, an end point for the travel way portion, a directionality (e.g., direction of traffic flow), and/or connectivity identifiers for other travel way portions that are predecessors and/or successors to a given travel way portion. Map data 118 can also include the identity and location of different items than travel ways, including but not limited to buildings, maintenance/service locations for the vehicles, parking areas, traffic signs, traffic lights, traffic control devices, and/or any other map data that provides information that assists the vehicle computing system 100 in comprehending and perceiving its surrounding environment and its relationship thereto.

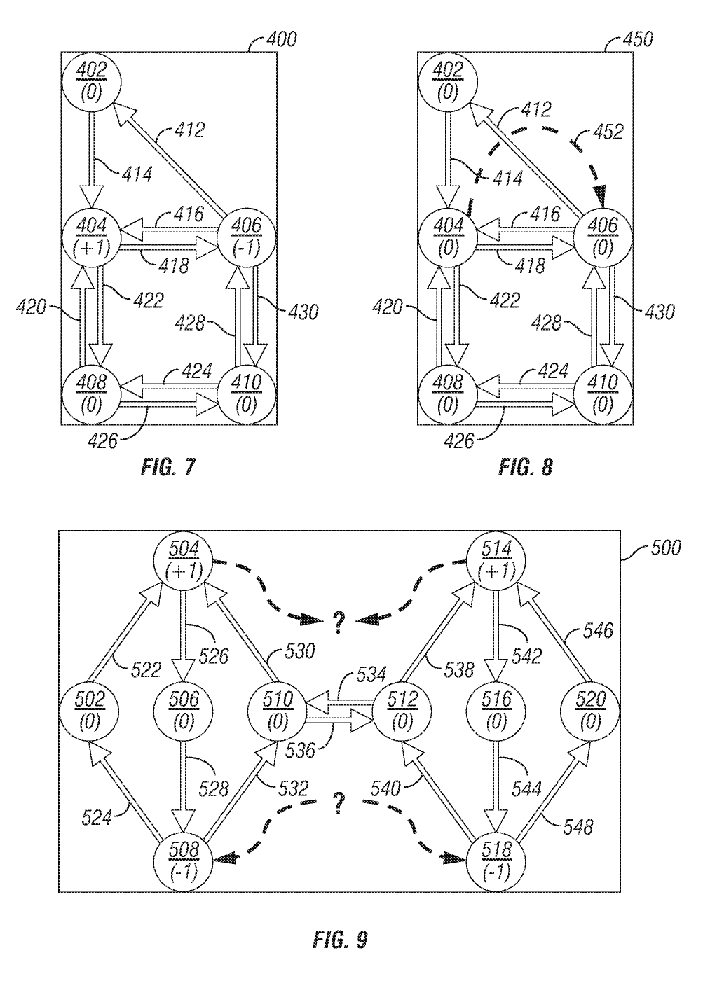

Referring still to FIG. 1, the vehicle computing device(s) 106 can also retrieve or otherwise obtain coverage plan data 120 that provides information descriptive of one or more travel routes for vehicle 102 to navigate. Such travel routes described by coverage plans provided within coverage plan data 120 can include a set of travel way portions within a map of a geographic area. In some implementations, coverage plan data 120 includes detailed information about the travel routes for vehicle navigation. In some implementations, coverage plan data 120 includes information used by route determiner 122 to determine the travel routes for vehicle navigation. In some implementations, coverage plan data 120 can include a coverage plan describing a travel route that is designed to traverse each travel way portion in a predetermined set of travel way portions at least once while reducing total travel cost (e.g., defined by a travel distance, number and/or types of turns, etc.) over all travel way portions. In some implementations, a coverage plan within coverage plan data 120 can also reduce turn angles and/or eliminate u-turns in order to provide a coverage plan that is generally safe and easy for implementation by vehicle 102 as it is manually or automatically controlled to navigate along the initial travel route. Additional description regarding more particular types and examples of coverage plans included within coverage plan data 120 is provided relative to FIGS. 7-21.

The computing device(s) 106 can also include a route determiner 122 configured to determine travel routes for vehicle 102 based at least in part on the map data 118 evaluated relative to the coverage plan data 120. In some examples, travel routes can be determined by route determiner 122 in accordance with a navigational objective (e.g., traversing each travel way portion in a set of travel way portions identified in coverage plan data 120 at least once while reducing total travel cost). In some examples, travel routes determined by route determiner 122 can include revised navigational instructions for returning a vehicle to another location within the travel route when vehicle 102 encounters an expected or unexpected deviation from a travel route (e.g., a travel route included in coverage plan data 120). In some examples, revised navigation instructions determined by route determiner 122 can include instructions to reroute vehicle 102 to navigate the next permitted travel way portion not yet navigated within a travel route. Travel routes determined by route determiner 122 can include, for example, a sequence of multiple travel way portions along which a vehicle 102 can plan to be manually or automatically navigated.

When included within vehicle 102, a perception system 110 can identify one or more objects that are proximate to the vehicle 102 based on sensor data received from the one or more sensors 104 and/or the map data 118. In particular, in some implementations, the perception system 110 can determine, for each object, state data that describes a current state of such object. As examples, the state data for each object can describe an estimate of the object's: current location (also referred to as position); current speed (also referred to as velocity); current acceleration; current heading; current orientation; size/footprint (e.g., as represented by a bounding shape such as a bounding polygon or polyhedron); class (e.g., vehicle versus pedestrian versus bicycle versus other); yaw rate; and/or other state information. In some implementations, the perception system 110 can determine state data for each object over a number of iterations. In particular, the perception system 110 can update the state data for each object at each iteration. Thus, the perception system 110 can detect and track objects (e.g., vehicles) that are proximate to the vehicle 102 over time.

The prediction system 112 can receive the state data from the perception system 110 and predict one or more future locations for each object based on such state data. For example, the prediction system 112 can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system 114 can determine a motion plan for the vehicle 102 based at least in part on the travel route determined by route determiner 122 and/or the predicted one or more future locations for the object and/or the state data for the object provided by the perception system 110. Stated differently, given information about the current locations of objects and/or predicted future locations of proximate objects, as well as a predetermined travel route, the motion planning system 114 can determine a motion plan for the vehicle 102 that best navigates the vehicle 102 along the determined travel route relative to the objects at such locations.

As one example, in some implementations, the motion planning system 114 can determine a cost function for each of one or more candidate motion plans for the vehicle 102 based at least in part on the current locations and/or predicted future locations of the objects. For example, the cost function can describe a cost (e.g., over time) of adhering to a particular candidate motion plan. For example, the cost described by a cost function can increase when the vehicle 102 expects to reach impact with another object and/or deviates from a preferred pathway (e.g., a predetermined travel route).

Thus, given information about the current locations and/or predicted future locations of objects, the motion planning system 114 can determine a cost of adhering to a particular candidate pathway. The motion planning system 114 can select or determine a motion plan for the vehicle 102 based at least in part on the cost function(s). For example, the motion plan that minimizes the cost function can be selected or otherwise determined. The motion planning system 114 can provide the selected motion plan to a vehicle controller 116 that controls one or more vehicle controls 108 (e.g., actuators or other devices that control throttle, steering, braking, etc.) to execute the selected motion plan.

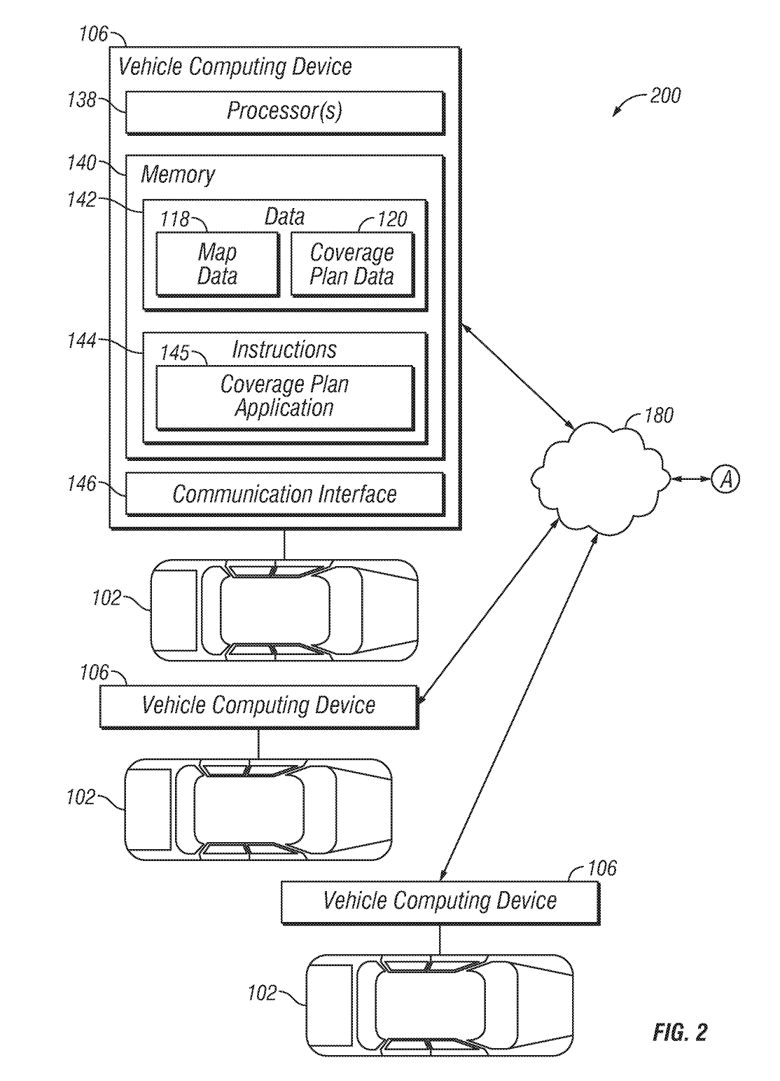

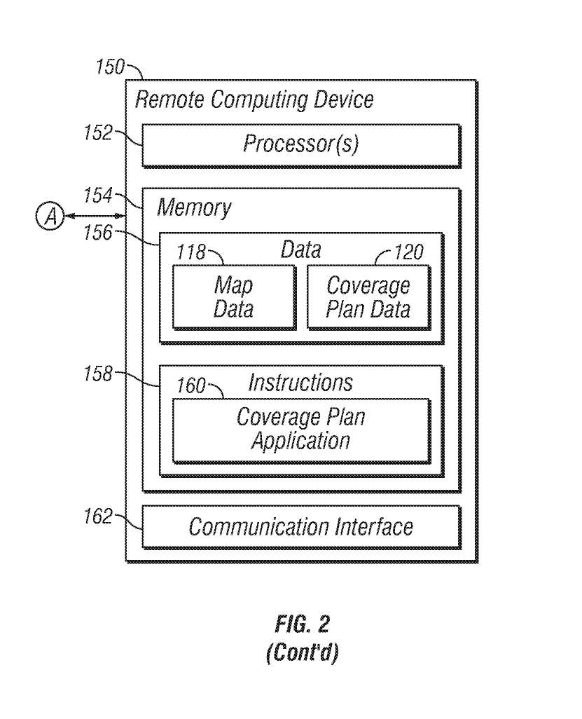

Each of the perception system 110, the prediction system 112, the motion planning system 114, the vehicle controller 116, and the route determiner 122 can include computer logic utilized to provide desired functionality. In some implementations, each of the perception system 110, the prediction system 112, the motion planning system 114, the vehicle controller 116, and the route determiner 122 can be implemented in hardware, firmware, and/or software controlling a general purpose processor. For example, in some implementations, each of the perception system 110, the prediction system 112, the motion planning system 114, the vehicle controller 116 and the route determiner 122 includes program files stored on a storage device, loaded into a memory and executed by one or more processors. In other implementations, each of the perception system 110, the prediction system 112, the motion planning system 114, the vehicle controller 116, and the route determiner 122 includes one or more sets of computer-executable instructions that are stored in a tangible computer-readable storage medium such as RAM hard disk or optical or magnetic media, as is further described in FIG. 2.

FIG. 2 depicts a block diagram of an example computing system 200 according to example embodiments of the present disclosure. In particular, FIG. 2 illustrates an example implementation of the present disclosure in which one or more remote computing devices 150 are communicatively coupled with one or more vehicle computing devices 106 over a network 180. Each vehicle computing device 106 can be part of a vehicle computing system 100 associated with a particular vehicle 102. It should be appreciated that FIG. 2 illustrates only one example computing system 200 that can be used to implement the present disclosure. Other computing systems can be used as well.

Each vehicle computing device 106 can include one or more processors 138 and a memory 140. The one or more processors 138 can be any suitable processing device (e.g., a processor core, a microprocessor, an ASIC, a FPGA, a controller, a microcontroller, etc.) and can be one processor or a plurality of processors that are operatively connected. The memory 140 can include one or more non-transitory computer-readable storage mediums, such as RAM, ROM, EEPROM, EPROM, flash memory devices, magnetic disks, etc., and combinations thereof. The memory 140 can store data 142 and instructions 144 which are executed by the processor 138 to cause the vehicle computing device 106 to perform operations. Data 142 can include map data 118 and coverage plan data 120. Instructions 144 can include coverage plan application 145 configured to implement one or more steps, features or aspects of example methods for generating and/or implementing coverage plans.

The vehicle computing device(s) 106 can obtain map data 118 and/or coverage plan data 120 via interaction with the remote computing device(s) 150 that are communicatively coupled over the network 180. The remote computing device(s) 150 can be separate from the vehicle computing device(s) 106 and provided in a location remote from the vehicle computing device(s) 106, for instance, in a central control system associated with a service provider, owner, and/or fleet operator controlling a fleet of vehicles 102.

The one or more remote computing device(s) 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the remote computing device(s) 150 to perform operations. The data 156 can include map data 118 and coverage plan data 120 that can be relayed over network 180 to one or more vehicle computing devices 106 associated with respective vehicles 102. Instructions 158 can include a coverage plan application 160 configured to implement one or more steps, features or aspects of example methods for generating and/or implementing coverage plans.

Referring still to FIG. 2, the network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). In some examples, vehicle computing device(s) 106 and/or remote computing device(s) 150 can further include one or more communication interfaces 146, 162, including any suitable components (transmitters, receivers, ports, controllers, antennas, etc.) for interfacing with network 180 or one or more other networks.

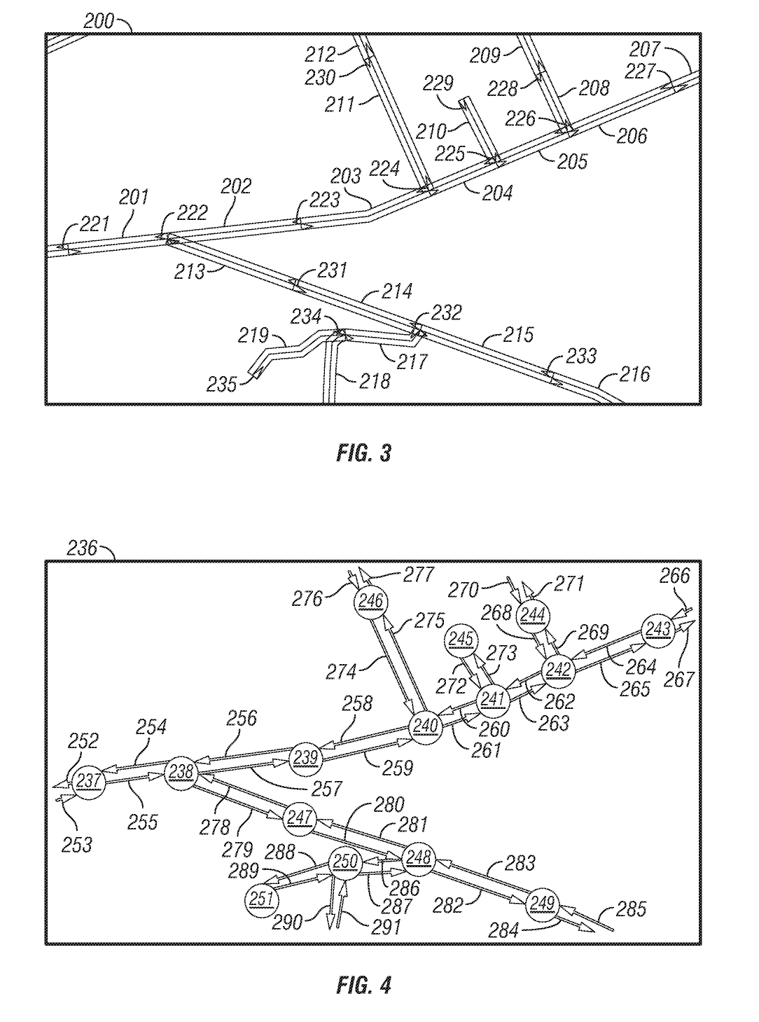

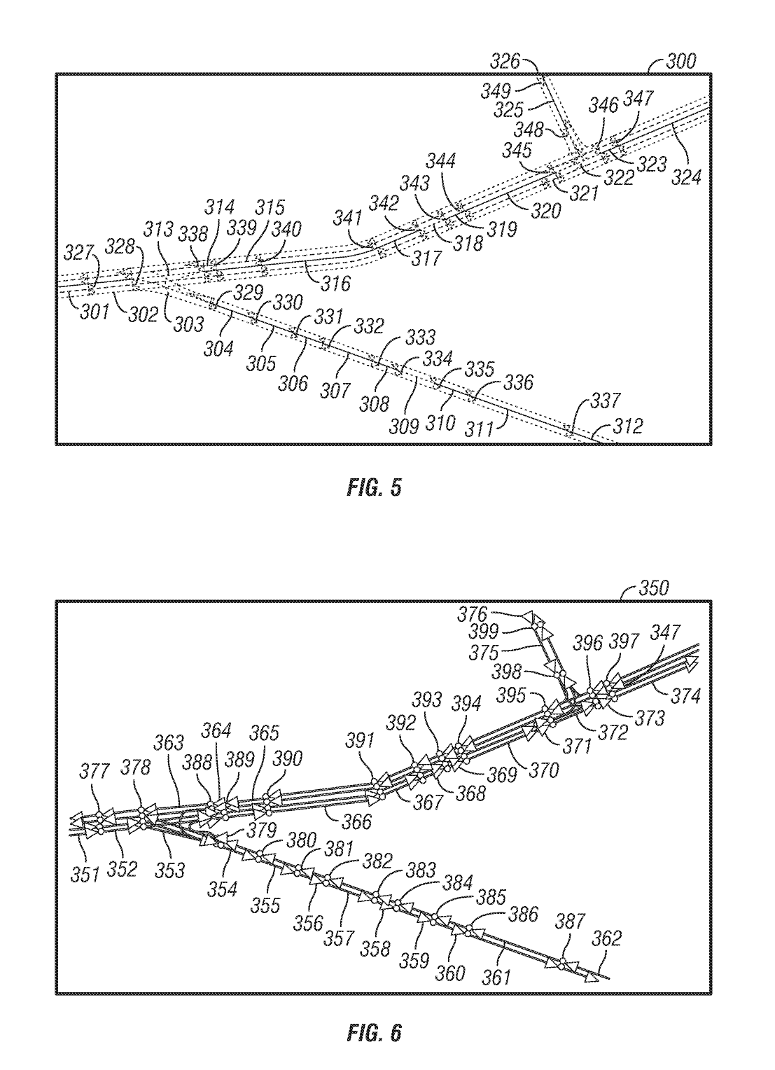

FIGS. 3 and 5 depict first and second example aspects of map data 118, particularly map data relative to illustrated travel way portions, according to example embodiments of the present disclosure. FIGS. 4 and 6 depict example coverage graphs of nodes and edges transformed from the example map data of FIGS. 3 and 5. As previously described, map data 118 can include a wealth of information regarding the identity and location of different travel ways (e.g., roads, road segments, lanes, lane segments, parking lanes, turning lanes, bicycle lanes, or other portions of a particular travel way), buildings, maintenance/service locations for the autonomous vehicles, parking areas, traffic signs, traffic lights, traffic control devices, and/or any other map data that provides information that assists the computing system in comprehending and perceiving its surrounding environment and its relationship thereto. The particular identifiers discussed in FIGS. 3 and 5 for representing map data 118 can also be used to represent coverage plan data 120 and/or travel routes determined by route determiner 122.

Referring now to FIG. 3, a first example portion of map data 200 includes a plurality of travel way portions and connections among adjacent travel way portions. More particularly, map data 200 includes travel way portions 201-219 and connections 221-235. In the example of FIG. 3, each travel way portion 201-219 can correspond to a road segment that includes one or more lane segments. For example, each travel way portion 201-219 in FIG. 3 is depicted as including three lane segments (e.g., a first lane segment for traveling in a first direction, a second lane segment for traveling in a second direction (e.g., opposing the first direction), and a third center lane for turning). In the example of FIG. 3, connections 221-235 can generally correspond to a link between two or more adjacent travel way portions 201-219. In some particular instances, a connection can correspond to an intersection (e.g., a point at which more than two travel way portions intersect or are connected). For instance, connections 222, 224, 225, 226, 232, and 234 of FIG. 3 correspond to intersections.

In some implementations of the disclosed technology, map data can be transformed into a coverage graph of nodes and edges. FIG. 4 depicts an example coverage graph 236 of nodes and edges resulting from a transformation of the map data 200 shown in FIG. 3. Each edge in coverage graph 236 represents a travel way portion from map data 200, while each node in coverage graph 236 represents an intersection or connection between adjacent travel way portions from map data 200. For example, nodes 237-251 within coverage graph 236 of FIG. 4 correspond to connections 221-235 within map data 200 of FIG. 3. In addition, edges 252-291 within coverage graph 236 correspond to travel way portions 201-219 within map data 200 of FIG. 3. Coverage graph 236 of FIG. 4 is considered to be strongly connected because an edge is provided in both directions between each pair of connected nodes in the coverage graph 236. For example, connected nodes 238 and 239 are connected by edges 256 and 257, including edge 256 for travel in a first direction and edge 257 for travel in a second direction (e.g., opposing the first direction).

Referring now to FIG. 5, a second example portion of map data 300 includes a plurality of travel way portions and connections among adjacent travel way portions. More particularly, map data 300 includes travel way portions 301-326 and connections 327-349. In the example of FIG. 5, each travel way portion 301-326 can correspond to a road segment that includes one or more lane segments. For example, each travel way portion 301-326 is depicted as including either two lane segments or four lane segments (e.g., one or two first lane segments for traveling in a first direction, and one or two second lane segments for traveling in a second direction (e.g., opposing the first direction)). In the example of FIG. 5, connections 327-349 can generally correspond to a link between two or more adjacent travel way portions. Some connections in map data 300, namely connections 328/338 and 345/346 of FIG. 5 also correspond to intersections.

FIG. 6 depicts an example coverage graph 350 of nodes and edges resulting from a transformation of the map data 300 shown in FIG. 5. Each edge in coverage graph 350 represents a travel way portion from map data 300, while each node in coverage graph 350 represents an intersection or connection between adjacent travel way portions from map data 300. For example, edges 351-376 within coverage graph 350 of FIG. 6 correspond to travel way portions 301-326 within map data 300 of FIG. 5. In addition, nodes 377-399 within coverage graph 350 of FIG. 6 correspond to connections 327-349 within map data 300 of FIG. 5. Whereas connections 221-235 of FIG. 3 more generally represent connections between adjacent road segments, connections 327-349 of FIG. 5 more specifically represent connections between adjacent lane segments. As such, the style of coverage graph 350 of FIG. 6 would include more nodes and edges to represent the same travel way portions and connections as the style of coverage graph 236 of FIG. 4.

FIGS. 7 and 8 are generally directed to a first example aspect of generating a coverage plan according to example embodiments of the present disclosure, and are more particularly directed to generating an enhanced coverage plan. More particularly, FIGS. 7 and 8 depict aspects of enhancing a coverage graph using Eulerian balancing. In some implementations, Eulerian balancing can be used to enhance a coverage graph of nodes and edges before the coverage graph is used at least in part to determine a coverage plan or travel route described by the coverage plan. For example, additional artificial edges can be generated between unbalanced nodes in a coverage graph. Unbalanced nodes can correspond to those nodes that do not have an equal number of incoming edges and outgoing edges. When considering an edge count for each node (e.g., the number of incoming edges minus the number of outgoing edges), balanced nodes can correspond to those nodes having an edge count of zero (0) and unbalanced nodes can correspond to those nodes having a non-zero edge count (e.g., −2, −1, +1, +2, etc.). A node characterized by a positive edge count can correspond to a node having one or more extra incoming edges, while a node characterized by a negative edge count can correspond to a node having one or more extra outgoing edges.

FIG. 7 depicts an example of determining which nodes in a coverage graph 400 are unbalanced. Coverage graph 400 includes five nodes 402, 404, 406, 408, and 410. In order to determine which nodes 402-410 are unbalanced, an edge count can be determined at each node. The edge count can correspond to the number of incoming edges for a given node minus the number of outgoing edges for that node. As such, node 402 can be determined to have an edge count of zero (0) because the number of incoming edges (one incoming edge corresponding to edge 412) minus the number of outgoing edges (one outgoing edge corresponding to edge 414) equals zero. Node 404 can be determined to have an edge count of positive one (+1) because the number of incoming edges (three incoming edges corresponding to edges 414, 416, 420) minus the number of outgoing edges (two outgoing edges corresponding to edges 418 and 422) equals positive one. Node 406 can be determined to have an edge count of negative one (−1) because the number of incoming edges (two incoming edges corresponding to edges 418 and 428) minus the number of outgoing edges (three outgoing edges corresponding to edges 412, 416, and 430) equals negative one. Node 408 can be determined to have an edge count of zero (0) because the number of incoming edges (two incoming edges corresponding to edges 422 and 424) minus the number of outgoing edges (two outgoing edges corresponding to edges 420 and 426) equals zero. Node 410 can be determined to have an edge count of zero (0) because the number of incoming edges (two incoming edges corresponding to edges 426 and 430) minus the number of outgoing edges (two outgoing edges corresponding to edges 424 and 428) equals zero. Based on the determined edge counts in the example coverage graph 400 of FIG. 7, nodes 402, 408, and 410 are determined to be balanced nodes, while nodes 404 and 406 are determined to be unbalanced nodes.

FIG. 8 depicts an example of generating additional artificial edges between unbalanced nodes in a coverage graph. More particularly, coverage graph 450 of FIG. 8 modifies the coverage graph 400 of FIG. 7 so that all nodes 402-410 are balanced. In general, balancing nodes in a coverage graph can include generating an additional artificial edge between each node having a non-zero edge count (e.g., +1, −1, +2, −2, etc.) and another node having a non-zero edge count. For example, an additional artificial edge can be generated from a node having a positive edge count to a node having a negative edge count. If a node has N unbalanced edges, then N additional artificial edges can be added into or out of that node. In the specific example of FIG. 8, nodes 404 and 406 each have one (1) unbalanced edge and thus require one (1) additional artificial edge. Balancing can be achieved in this example by generating an additional artificial edge 452 as an outgoing edge from node 404 and an incoming edge to node 406. If the edge count for nodes 402-410 is determined after including additional artificial edge 452, the edge count for all nodes 402-410 is determined to be zero (0). As such, all nodes 402-410 in coverage graph 450 of FIG. 8 are balanced nodes.

FIGS. 9-11 are generally directed to a second example aspect of generating a coverage plan according to example embodiments of the present disclosure, and are more particularly directed to generating an enhanced coverage plan. More particularly, FIGS. 9-11 depict example aspects of a matching algorithm that can be used to help balance nodes when a coverage graph contains more than one unique unbalanced node having a positive edge count and/or more than one unique unbalanced node having a negative edge count. In some implementations, a matching algorithm can be employed to determine a preferred path for the additional artificial edges generated in the Eulerian balancing process. The example of FIGS. 9-11 employs a bipartite matching algorithm, although other matching algorithms are also possible.

Referring now to FIG. 9, example coverage graph 500 includes a plurality of nodes 502-520 that are variously connected by edges 522-548 as illustrated. Edge counts for nodes 502-520 are determined by determining the number of incoming edges minus the number of outgoing edges at each node. Nodes 502, 506, 510, 512, 516, and 520 all have edge counts of zero (0) and are thus considered to be balanced nodes. Nodes 504 and 514 have an edge count of positive one (+1), while nodes 508 and 518 have an edge count of negative one (−1). As such, nodes 504, 508, 514, and 518 are unbalanced. As such, additional artificial edges can be generated to balance nodes 504, 508, 514, and 518. A first possible set of matching paths to balance nodes 504, 508, 514, and 518 would involve generating additional artificial edges from node 504 to node 508 and from node 514 to node 518. A second possible set of matching paths to balance nodes 504, 508, 514, and 518 would involve generating additional artificial edges from node 504 to node 518 and from node 514 to node 508. Since there is more than possible set of matching paths resulting from more than one unique unbalanced node on both the positive and negative sides, a matching algorithm can help determine the optimal matching path for balancing nodes 504, 508, 514, and 518.

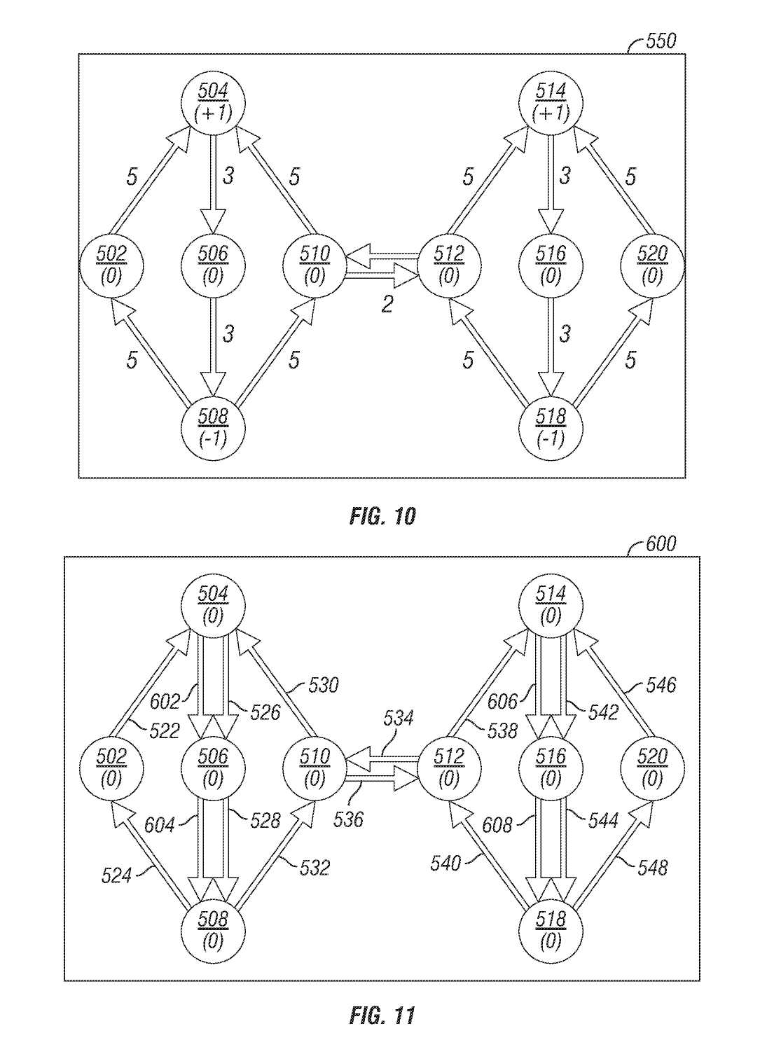

Referring now to FIG. 10, example coverage graph 550 depicts an example of determining the shortest path costs between the unbalanced nodes 504, 508, 514, and 518 depicted in FIG. 9. In some implementations, path costs between nodes can be determined proportionately based on the distance of edges between those nodes (e.g., distance of the corresponding travel way portions). For purposes of the example in FIG. 10, assume that the path cost to traverse edges 522, 524, 530, 532, 538, 540, 546, and 548 is five (5), the path cost to traverse edges 526, 528, 542, and 544 is three (3) and the path cost to traverse edges 534 and 536 is two (2). A cost for the first possible set of matching paths (shortest path from node 504 to node 508 and shortest path from node 514 to node 518) would be calculated as the cost to traverse edges 526 and 528 (e.g., 3+3=6) and the cost to traverse edges 542 and 544 (e.g., 3+3=6), resulting in a total cost of 6+6=12. A cost for the second possible set of matching paths (shortest path from node 504 to node 518 and shortest path from node 514 to node 508) would be calculated as the cost to traverse edges 542, 544, 540, 534, 530, 526, and 528 (e.g., 3+3+5+2+5+3+3=24) and the cost to traverse edges 526, 528, 532, 536, 538, 542, and 544 (e.g., 3+3+5+2+5+3+3=24), resulting in a total cost of 24+24=48. The optimal matching path for balancing nodes 504. 508, 514, and 518 can be selected as the set of matching paths having the lowest total cost. In the example of FIG. 10, the first possible set of matching paths (shortest path from node 504 to node 508 and shortest path from node 514 to node 518) can be selected since its total cost of twelve (12) is less than the total cost of the second set of matching paths which is forty-eight (48).

Referring now to FIG. 11, example coverage graph 600 depicts an example of generating additional artificial edges between unbalanced nodes using the optimal set of matching paths determined in FIG. 10. A first set of artificial edges can be generated between nodes 504 and 508, corresponding to an extra set of edges 602 and 604. Additional artificial edge 602 parallels original edge 526 between node 504 and node 506, while additional artificial edge 604 parallels original edge 528 between node 506 and node 508. A second set of artificial edges can be generated between nodes 514 and 518, corresponding to an extra set of edges 606 and 608. Additional artificial edge 606 parallels original edge 542 between node 514 and node 516, while additional artificial edge 608 parallels original edge 544 between node 516 and node 518. In some examples, coverage graph 600 can be referred to as an enhanced coverage graph corresponding to a coverage graph that is enhanced relative to coverage graphs 500 and 550 of FIGS. 9 and 10.

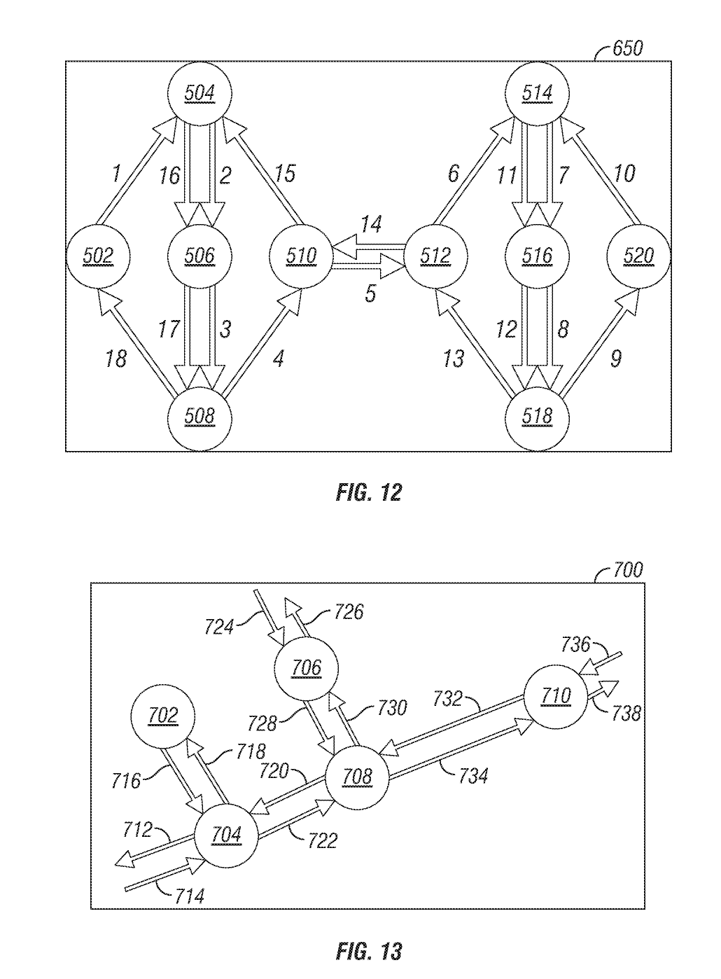

FIG. 12 is generally directed to a third example aspect of generating a coverage plan according to example embodiments of the present disclosure, and is more particularly directed to determining an Eulerian path. FIG. 12 depicts an example enhanced coverage graph 650 that is similar to enhanced coverage graph 600 of FIG. 11, but that additionally depicts aspects of determining a coverage plan descriptive of a travel route along edges in a coverage graph. More particularly FIG. 12 depicts an example travel route that traverses each edge in enhanced coverage graph 600/650 at least once while reducing total travel cost over all edges. The initial travel route can be determined in FIG. 12, for example, by determining an Eulerian path among nodes 504-520 and edges 522-548 and 602-608 in the enhanced coverage graph 600 of FIG. 11.

Referring still to FIGS. 11-12, determining an Eulerian path in enhanced coverage graph 600/650 can include determining a main path by identifying node 502 as a start node and traversing consecutive edges within enhanced coverage graph 600/650 until reaching the identified start node (e.g., node 502) again. A main path starting at node 502 could correspond, for example, to a path traversing successive edges 522, 526, 528, and 524. Nodes within this main path (e.g., nodes 502, 504, 506, and 508) then can be checked to identify any remaining nodes having unvisited exits (e.g., outgoing edges not yet traversed as part of the main path). A first remaining node corresponds to node 508, having an unvisited exit along outgoing edge 532. Node 508 can thus form a subsequent starting node for a first sub-path along successive edges within enhanced coverage graph 600/650 not yet visited during the main path until returning to the subsequent starting node. A first sub-path starting at node 508 could correspond, for example, to a path traversing edges 532, 536, 538, 542, 544, 540, 534, 530, 602, and 604. This first sub-path can then be spliced into the main path between the remaining node identified as a subsequent starting node (e.g., node 508) and its original successor (e.g., node 502 as reached by edge 524). Such splicing would result in a main path successively traversing edges 522, 526, 528, 532, 536, 538, 542, 544, 540, 534, 530, 602, 604, and 524. After splicing the first sub-path into the main path of FIGS. 11-12, a second remaining node can be identified as node 514, which has an unvisited exit along outgoing edge 606. Node 514 can thus form a subsequent starting node for a second sub-path along successive edges within enhanced coverage graph 600/650 not yet visited during the main path and first sub-path. A second sub-path starting at node 514 could correspond, for example, to a path traversing edges 606, 608, 548, and 546. This second sub-path can then be spliced into the main path between the remaining node identified as a subsequent starting node (e.g., node 514) and its original successor (e.g., node 516 as reached by edge 542). Such splicing would result in a main path successively traversing edges 522, 526, 528, 532, 536, 538, 606, 608, 548, 546, 542, 544, 540, 534, 530, 602, 604, and 524. At this point, all exits for all nodes 502-520 within enhanced coverage graph 600/650 have been visited. As such, the process of determining an Eulerian path in the example enhanced coverage graph 600/650 of FIG. 12 is complete. The successive edges traversed by the determined main path are consecutively numbered in FIG. 12 for ease of reference. This sequence of successive edges can form a travel route for a coverage plan in accordance with example aspects of the disclosed technology.

FIG. 13 is generally directed to a fourth example aspect of generating a coverage plan according to example embodiments of the present disclosure, and is more particularly directed to selecting edges that reduce turns within a path. Example coverage graph 700 includes a plurality of nodes 702-710 and a plurality of edges 712-738. If an Eulerian path is determined that includes traversing edge 722 from node 704 to node 708, the possible selections for a next successive outgoing edge from node 708 include edge 720, edge 730, and edge 734. In some implementations, determining an Eulerian path can include selecting the outgoing edge that reduces turns within the path (e.g., by reducing the angle difference between incoming and outgoing edges). For example, for a path reaching node 708 by following incoming edge 722, a path following outgoing edge 720 would result in an angle difference of about 180 degrees. A path following outgoing edge 730 would result in an angle difference of about 90 degrees, and a path following outgoing edge 734 would result in an angle difference of about 0 degrees. As such, selecting outgoing edge 734 after incoming edge 722 would minimize the angle difference between incoming and outgoing edges at node 708.

It should be appreciated that determining an Eulerian path may not always result in selecting an outgoing edge that minimizes turns, but that reduces turns relative to other options while still accomplishing an overarching objective of covering all edges in a set of edges at least once while reducing total travel cost. In some examples, reducing turns can correspond to picking any outgoing edge option (e.g., edge 730 or edge 734) over an edge option (e.g., edge 720) that corresponds to a u-turn within a travel path. In some implementations, u-turns can be minimized by reducing selection of an outgoing edge (e.g., edge 720) that has an angle difference of 180 degrees from a corresponding incoming edge (e.g., edge 722). In some implementations, outgoing edges that travel straight (e.g., have an angle difference as close to zero degrees as possible) relative to an incoming edge can be preferred over outgoing edges that turn (e.g., have a larger non-zero angle difference) relative to an incoming edge.

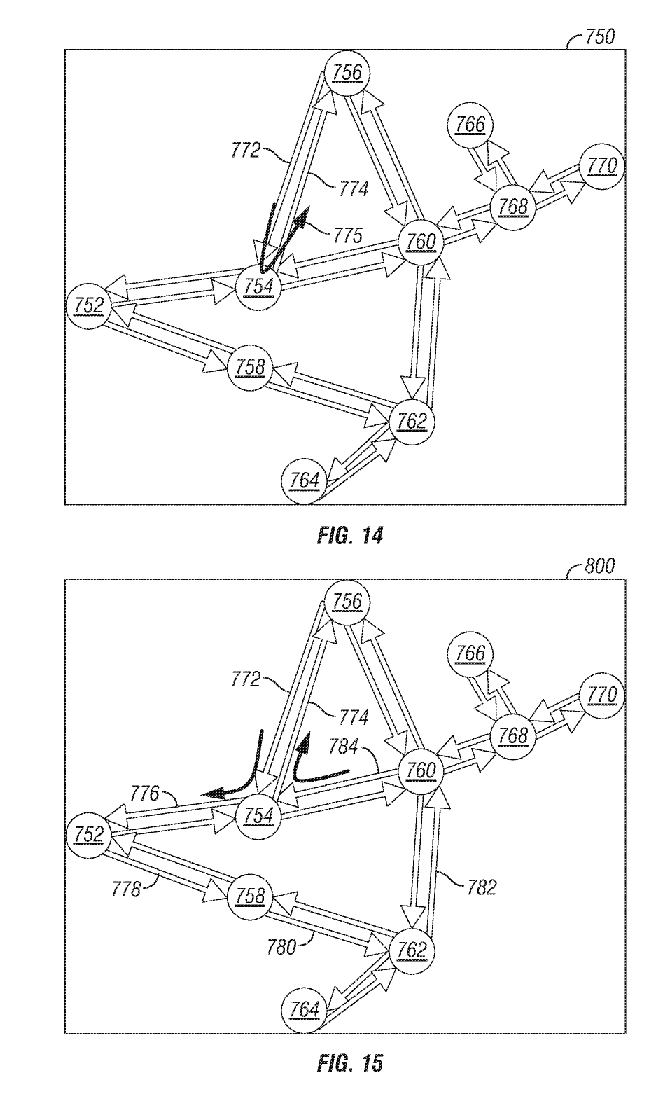

FIGS. 14-15 are generally directed to a fifth example aspect of generating an initial coverage plan according to example embodiments of the present disclosure, and are more particularly directed to selecting edges that reduce turns within a path. Example coverage graph 750 of FIG. 14 includes a plurality of nodes 752-770 and a plurality of edges connecting such nodes. If a coverage plan is computed with an initial path that successively traverses edge 772 from node 756 to node 754 followed by edge 774 from node 754 to node 756, then a u-turn 775 between first node 756 and second node 754 can be identified within the travel route. Determination of an alternate path between first node 756 and second node 754 can then be attempted.

FIG. 15 depicts an example coverage graph 800 similar to coverage graph 750 of FIG. 14, but depicting an example alternate path between first node 756 and second node 754. The example alternate path depicted in FIG. 15 by includes edges 772 and 774 but avoids u-turn 775 by successively traversing edges 772, 776, 778, 780, 782, 784, and 774. In this example, the initial path of FIG. 14 traversing edges 772 and 774 (and resulting in u-turn 775) can be replaced with the alternate path of FIG. 15 traversing edges 772, 776, 778, 780, 782, 784, and 774. In some implementations, a u-turn (e.g., the u-turn 775 of FIG. 14) can be replaced with an alternate path (e.g., the alternate path depicted in FIG. 15) when a cost associated with the alternate path is below a given threshold and/or below a cost associated with the u-turn. For example, if an alternate path would not require a vehicle to travel longer than a threshold distance (e.g., one kilometer), then a u-turn can be replaced by the alternate path.

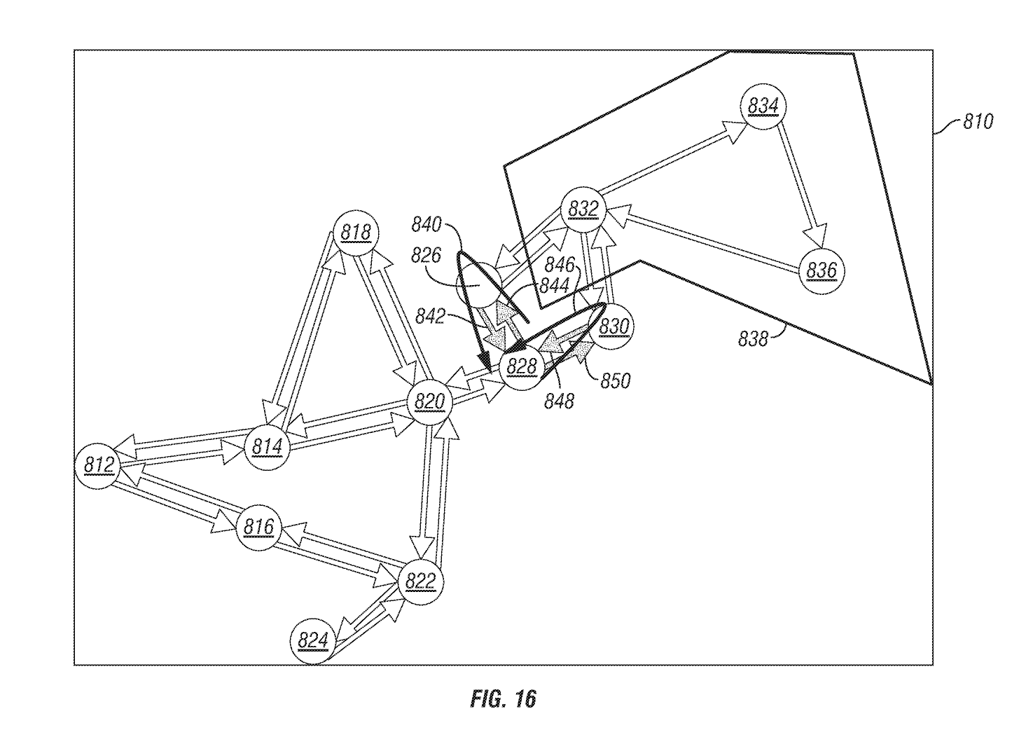

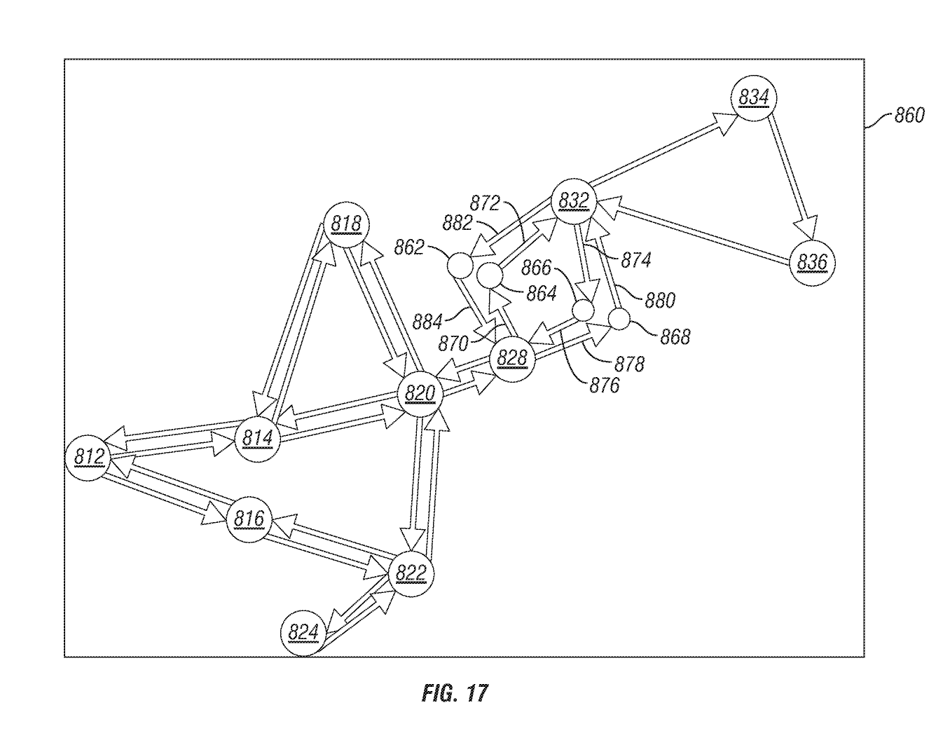

FIGS. 16-17 are generally directed to a sixth example aspect of generating an initial coverage plan according to example embodiments of the present disclosure, and are more particularly directed to selecting edges that reduce turns within a path. Example coverage graph 810 of FIG. 16 includes a plurality of nodes 812-836 and a plurality of edges connecting such nodes. In the example of FIG. 16, area 838 including nodes 832-836 is outside of an initial coverage plan. As such, nodes 826-830 are located at boundary points of a coverage plan including nodes 812-830, since nodes 826-830 are located along the periphery of coverage graph 810. Without use of nodes 832-836, a path between node 826 and 828 would involve a bounded u-turn 840 along edges 842 and 844. Similarly, a path between node 828 and node 830 would involve a bounded u-turn 846 along edges 848 and 850. In the example of FIG. 16, bounded u-turn 840 appears to exist between node 826 and 828 and bounded u-turn 846 appears to exist between node 828 and node 830 in the ordinary course of determining an Eulerian path among all nodes 812-830, but could be avoided if coverage graph 810 were to include additional artificial edges corresponding to travel way portions outside an initial coverage plan.

Referring now to FIG. 17, example coverage graph 860 corresponds to coverage graph 810 of FIG. 16 with the inclusion of additional artificial edges outside the initial coverage plan depicted in FIG. 16. More particularly, first node 826 associated with bounded u-turns 840 and 846 can be split into two unbalanced first nodes 862 and 864, while second node 530 associated with bounded u-turns 840 and 846 can be split into two unbalanced second nodes 866 and 868. A sub-path can then be determined that includes the unbalanced first nodes 862 and 864, the unbalanced second nodes 866 and 868 and one or more additional nodes (e.g., node 832) added to the coverage graph from an area outside the initial coverage plan. In the example of FIG. 17, a sub-path can be determined that successively traverses edges 870, 872, 874, and 876 or edges 878, 880, 882, and 884. The determined sub-path can then be spliced into the previously determined Eulerian path to create an improved travel route with reduced u-turns (e.g., a travel route without bounded u-turns 840 and 846).

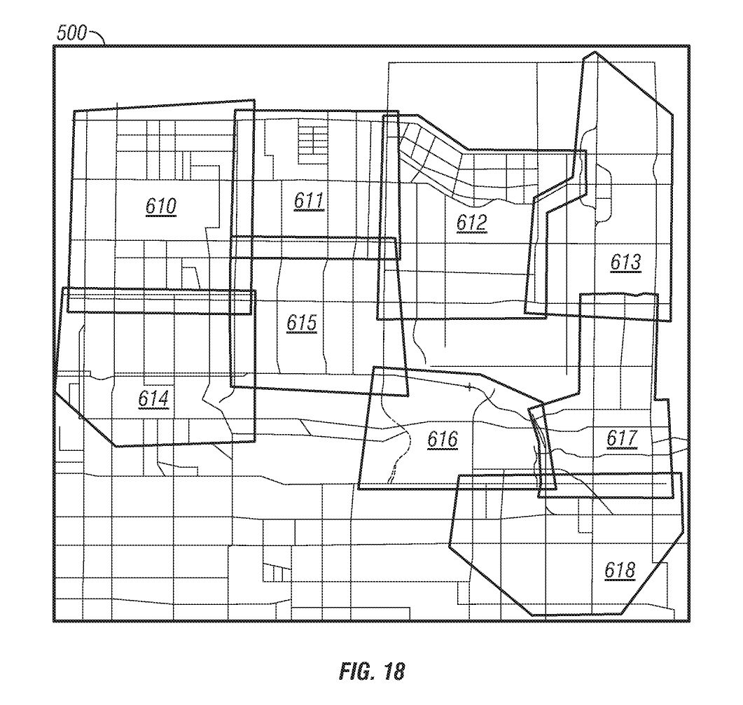

FIGS. 18-21 depict a seventh example aspect of generating a coverage plan according to example embodiments of the present disclosure. More particularly, FIGS. 18-21 depict features associated with the use of coverage bounds to identify which travel way portions within map data of a geographic area are intended for vehicle navigation in accordance with a coverage plan.

FIG. 18 depicts an example portion of map data 609 that is segmented into different coverage zones 610-618. Because a vehicle is controlled to navigate all travel way portions within a travel route in a coverage plan, it may be desired to keep the total length of a travel route (e.g., as measured in miles, kilometers, etc.) or time taken to navigate the travel route (e.g., as measured in hours, minutes, seconds, etc.) to a limited amount. One example approach for doing so is to determine a breakout for a coverage map area into different coverage zones. For example, FIG. 18 depicts a breakout for the coverage map area within map data 609 into several different coverage zones 610-618. Each coverage zone 610-618 corresponds to a subset of the geographic area depicted by map data 609. Although the coverage zones 610-618 depicted in FIG. 18 are shown as being characterized by different shapes and sizes, coverage zones could also be defined using a grid of similar shapes and sizes. In addition, although coverage zones 610-618 are depicted as having some overlap among neighboring coverage zones, other coverage zones can be configured without overlap. Coverage bounds (e.g., inclusion polygons) as described herein can be used to designate portions of map data within one or more respective coverage zones to be included in a coverage plan. For instance, a separate inclusion polygon can be created for each of the coverage zones 610-618 to describe in part the travel way portions within that coverage zone for navigation within a coverage plan.

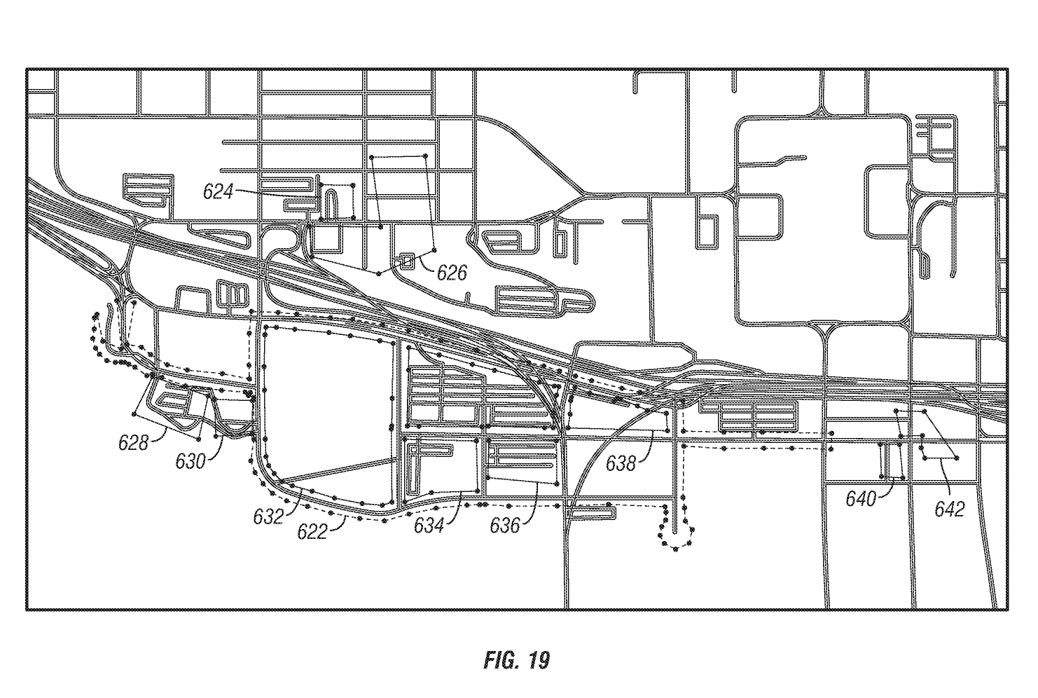

FIGS. 19-21 depict examples of how coverage bounds can be used to identify specific portions of map data to be included in (and optionally excluded from) a coverage plan. In general, a set of coverage bounds can be descriptive of one or more travel way portions to be included and zero or more travel way portions to be excluded from a coverage plan.

One specific example of coverage bounds involves the use of different types of polygons (e.g., inclusion, exclusion, optional exclusion) to broadly define geographic areas for navigation in a coverage plan. The number of vertices, number of edges, and/or overall shape of a polygon encompassing a particular geographic area can be customized in numerous ways to accomplish specific navigational coverage objectives. For instance, inclusion polygons can identify a geographic area that should be included or required for navigation in accordance with a particular coverage plan. Exclusion polygons can identify a geographic area that should be excluded or forbidden for navigation, while optional exclusion polygons can identify a geographic area that is not required to navigate but is permitted. A set of coverage bounds can include one or more inclusion polygons descriptive of one or more travel way portions to be included in a coverage plan and zero or more exclusion polygons descriptive of travel way portions to be excluded.

Evaluation of map data relative to a set of coverage bounds (e.g., inclusion and/or exclusion polygons) can help determine which travel way portions within the map data are required, permitted and/or forbidden. For example, any travel way portion within the map data that is completely enclosed by an inclusion polygon can be permitted and required for inclusion within a coverage plan. Any travel way portion within the map data that is completely enclosed or partially touched by an exclusion polygon can be forbidden for inclusion within a coverage plan. Any travel way portion within the map data that is completely enclosed or partially touched by an optional exclusion polygon can be permitted but not required. When a given travel way or travel way portion is included in both an inclusion polygon and an exclusion polygon, predetermined rules can be created for analyzing the travel way portions to determine whether they should be determined to be required, permitted and/or forbidden travel way portions. In one example, when a travel way portion is part of both an inclusion polygon and an exclusion polygon, such travel way portion can be excluded. In other words, determination as an excluded travel way portion can trump determination as an included travel way portion.

FIG. 19 more particularly depicts an example portion of map data 620 illustrated relative to a set of coverage bounds in the form of one or more inclusion and/or exclusion polygons. In FIG. 19, an inclusion polygon 622 has a predetermined boundary that encompasses a geographic area within a portion of the map data 620, and is configured to identify travel way portions within the map data 620 that are required for a coverage plan. Inclusion polygon 622 is represented in FIG. 19 using a solid line, although a specific color or other visual identifier can be used in association with the polygon. Exclusion polygons 624-642 also have a predetermined boundary that encompasses a geographic area within a portion of the map data 620. Exclusion polygons can be configured to identify travel way portions within map data 620 that are forbidden within a coverage plan. Exclusion polygons 624-642 are represented in FIG. 19 using a dotted line, although a specific color or other visual identifier can be used in association with the polygon. The boundary of each inclusion polygon 622 and exclusion polygon 624-642 can include any number of vertices and edges in a variety of configurations, and can sometimes be shaped relative to the locations of nearby travel way portions.

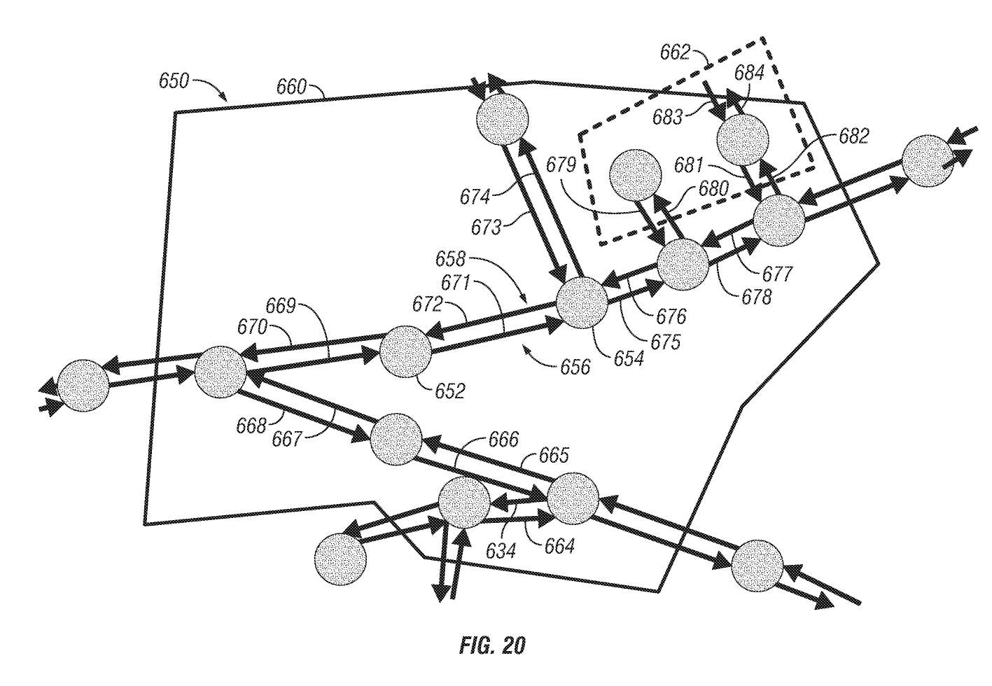

FIG. 20 depicts an example portion of map data 650 whose travel way portions have been transformed into a graph of nodes and edges. The different nodes can correspond to starting points and ending points for different travel way portions and the different edges can correspond to connectivity vectors describing a direction of travel. For example, a travel way portion 671 can correspond to a lane segment defined by starting point node 652, ending point node 654 and connectivity vector 656, while travel way portion 672 can correspond to a lane segment defined by starting point node 654, ending point node 652 and connectivity vector 658. Each travel way portion (e.g., road segment and/or lane segment) can be similarly defined as a combination of identifiers, nodes and/or edges.

FIG. 20 also depicts example coverage bounds in the form of an inclusion polygon 660 and an exclusion polygon 662. Map data 650 can be evaluated relative to this set of coverage bounds in order to determine which travel way portions are included and which travel way portions are excluded. For instance, included travel way portions can be determined as those travel way portions that are completely enclosed by an inclusion polygon. In the example of FIG. 20, travel way portions 663-682 are completely enclosed by inclusion polygon 660 and can thus be determined as included travel way portions. Excluded travel way portions can be determined as those travel way portions that are either completely enclosed or partially touched by an exclusion polygon. Because travel way portions 679-684 in FIG. 20 are either completely enclosed or partially touched by exclusion polygon 662, travel way portions 679-684 are determined to be excluded travel way portions. When a travel way portion is part of both an inclusion polygon and an exclusion polygon, such travel way portion should be excluded. In other words, determination as an excluded travel way portion trumps determination as an included travel way portion. Because of this hierarchical application of polygonal coverage bounds, travel way portions 679-682 are determined to be excluded travel way portions because they are touched by exclusion polygon 662 even though they are also completely enclosed by inclusion polygon 660.

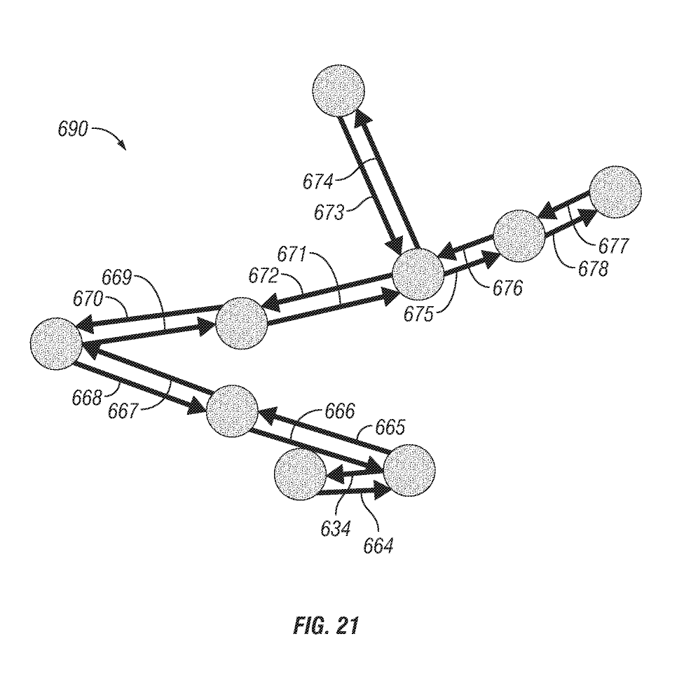

FIG. 21 depicts an example portion of map data 690 that has been evaluated relative to the coverage bounds depicted in FIG. 20. Map data 690 includes only included or required travel way portions (e.g., travel way portions 663-678) and does not include any excluded travel way portions (e.g., travel way portions 679-684) as determined based on the coverage bounds of FIG. 20. The map data 690 evaluated relative to the coverage bounds (e.g., inclusion polygon 660 and exclusion polygon 662) can then be used to determine a coverage plan including a travel route that traverses all included/required travel way portions within the set of travel way portions depicted in FIG. 21

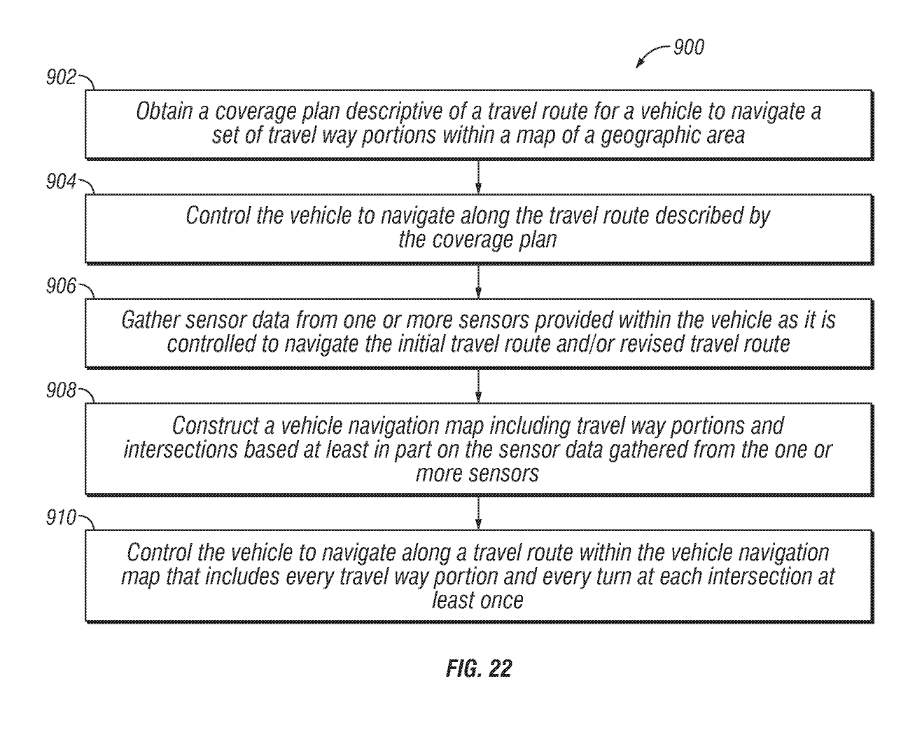

FIG. 22 depicts a flow chart of an example method 900 for implementing a coverage plan according to example embodiments of the present disclosure. One or more portion(s) of the method 900 can be implemented by one or more computing devices such as, for example, the computing device(s) 106 of FIG. 1. Moreover, one or more portion(s) of the method 900 can be implemented as an algorithm on the hardware components of the device(s) described herein (e.g., as in FIGS. 1 and 2). FIG. 18 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

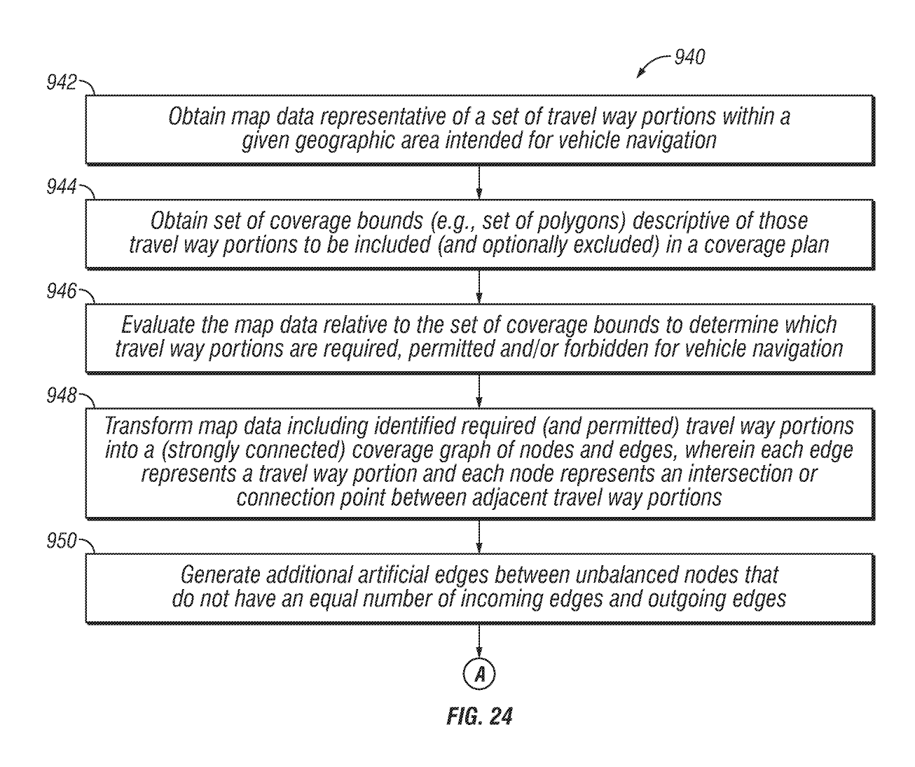

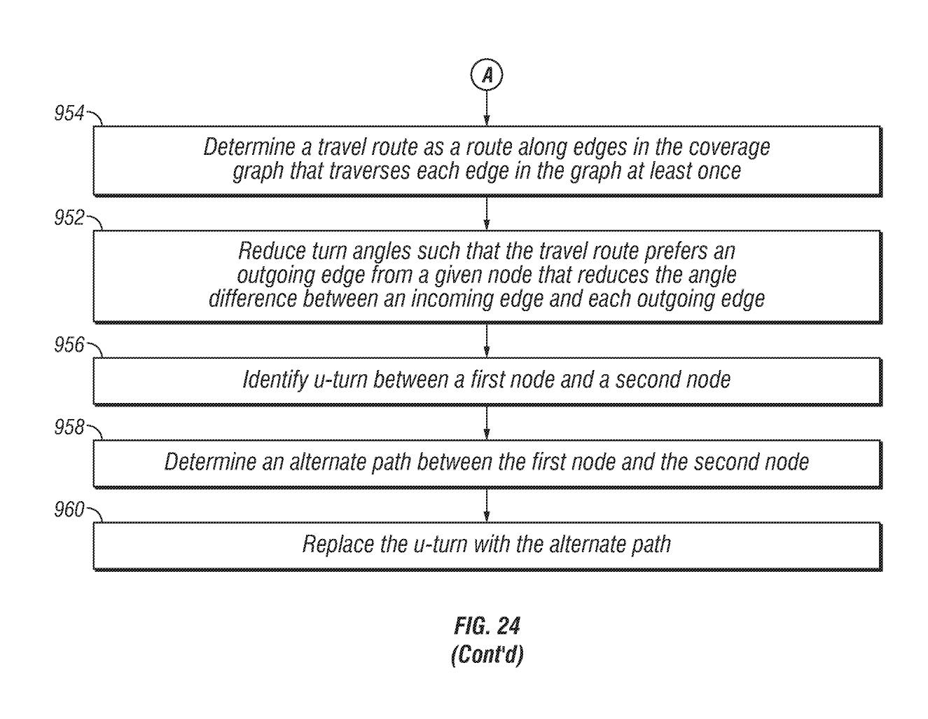

At (902), the method 900 can include obtaining a coverage plan descriptive of a travel route for a vehicle to navigate a set of travel way portions within a map of a geographic area. In some implementations, the travel route described by the coverage plan obtained at (902) can include all travel way portions in the set of travel way portions at least once while reducing total travel cost (e.g., defined by a travel distance, number and/or types of turns, etc.) over all travel way portions in the set of travel way portions. The coverage plan obtained at (902) can also reduce turn angles and/or eliminate u-turns in order to provide a coverage plan that is safer and easier for implementation by vehicles controlled to navigate along the travel route at (904). In some particular implementations, the coverage plan obtained at (902) can also be generated. A more particular example of generating a coverage plan is depicted in FIG. 24.

Referring still to FIG. 22, at (904), the method 900 can include controlling the vehicle to navigate along the travel route described by the travel plan obtained at (902). For example, a vehicle 102 as depicted in FIGS. 1-2 can be controlled manually by a human driver and/or automatically by an autonomy system provided within vehicle 102.

At (906), the method 900 can include gathering sensor data from one or more sensors (e.g., sensors 104 depicted in FIG. 1) provided within vehicle 102 as the vehicle 102 is controlled to navigate the travel route at (904). Sensor data gathered at (906) can be used in a variety of manners. For example, the position of a vehicle 102 as determined by positioning system 105 and/or other sensor data can be compared with map data 118 used to generate coverage plan data 120 or with the coverage plan data 120 itself to verify the accuracy of such data. The sensor data gathered at (906) can additionally or alternatively be added to existing map data 118 to provide more detailed information regarding a geographic area.

In some implementations, sensor data gathered at (906) can be used to construct at (908) a vehicle navigation map based at least in part on the sensor data. A vehicle navigation map constructed at (908) can include, for instance, a plurality of travel way portions and intersections between adjacent travel way portions as traveled by the vehicle along a travel route. In some implementations, a vehicle 102 can subsequently be controlled at (910) to navigate along a travel route within the vehicle navigation map constructed at (908). Such travel route can include, for example, every travel way portion within the coverage map at least once and every turn at each intersection in the coverage map at least once. The vehicle navigation maps constructed at (908) and navigated at (910) facilitate the gathering and controlled use of data within every lane and every turn within a set of travel ways, which is desirable for purposes of having a comprehensive data set for controlling autonomous vehicles.

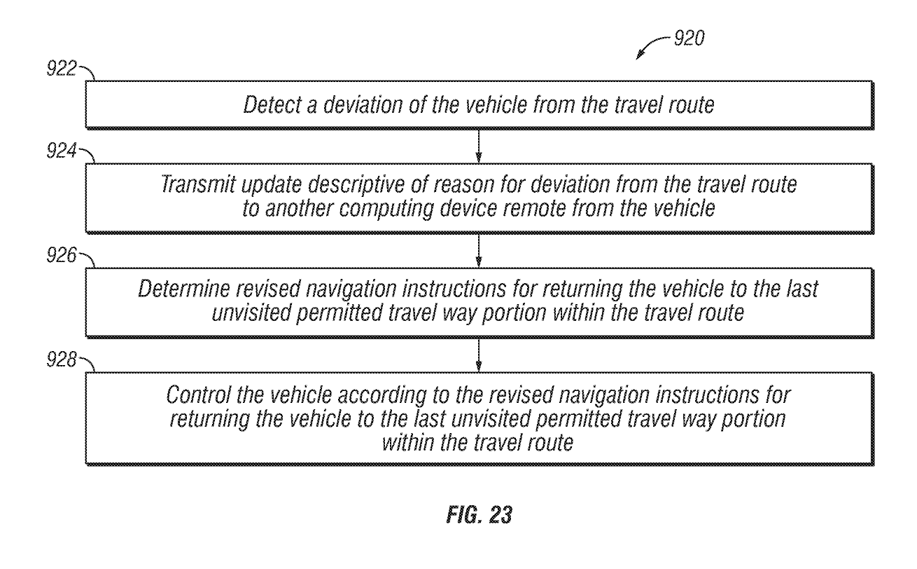

FIG. 23 depicts a flow chart of an example method 920 for addressing deviations from a coverage plan according to example embodiments of the present disclosure. One or more portion(s) of the method 920 can be implemented by one or more computing devices such as, for example, the computing device(s) 106 of FIG. 1. Moreover, one or more portion(s) of the method 900 can be implemented as an algorithm on the hardware components of the device(s) described herein (e.g., as in FIGS. 1 and 2). FIG. 23 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At (922), the method 920 can include detecting a deviation of the vehicle from the travel route, such as the travel route described by the coverage plan obtained at (902). In some implementations, detecting a deviation at (922) of a vehicle can be done by analyzing geographic location data from a positioning system 105 to track a vehicle 102 as it navigates along a travel route described by the coverage plan obtained at (902) and detecting positional deviations from the travel route. Deviations detected at (922) can arise from a number of reasons. For example, a vehicle 102 could make a wrong turn while following a travel route described by a coverage plan obtained at (902), or initial map data for a given geographic area could be incorrect or could change over time, or occurrences (e.g., construction, traffic accidents, special events) could make certain travel way portions temporarily impassible).

At (924), the method 920 can include transmitting an update descriptive of a reason for the deviation from the travel route detected at (922) to another computing device remote from the vehicle. The update can include an identification of one or more travel way portions that are currently incorrect or impassible, as well as a corresponding reason for the discrepancy. In some implementations, transmitting the update at (924) can correspond, for example, to transmitting the update at (924) over network 180 depicted in FIG. 2. For instance, the update can be transmitted at (924) from a vehicle computing device 106 associated with a given vehicle 102 to a vehicle computing device 106 associated with another vehicle 102 or to remote computing device 150. In variations, the update descriptive of a reason for the deviation from the travel route may be determined at (924) on-board the vehicle.

At (926), the method 920 can include determining revised navigation instructions for returning the vehicle to the last unvisited permitted travel way portion within the travel route. In some implementations, the revised navigation instructions determined at (926) can reroute a vehicle to navigate the next unvisited permitted travel way portion within the travel route described by the coverage plan obtained at (902). In some implementations, the revised navigation instructions determined at (926) can reroute a vehicle along permitted travel way portions within a coverage plan to the next required travel way portion not yet navigated in the coverage plan. In some instances, this approach of determining revised navigation instructions for returning a vehicle to a travel route can better help a vehicle accomplish its coverage plan goal after encountering a deviation.

At (928), the method 920 can include controlling the vehicle to navigate along the revised navigation instructions determined at (926). For example, a vehicle 102 as depicted in FIGS. 1-2 can be controlled manually by a human driver and/or automatically by an autonomy system provided within vehicle 102.

FIG. 24 depicts a flow chart of an example method 940 for generating a coverage plan according to example embodiments of the present disclosure. For example, a coverage plan generated using method 940 can correspond to the coverage plan obtained at (902) in method 900 of FIG. 22. One or more portion(s) of the method 940 can be implemented by one or more computing devices such as, for example, the one or more vehicle computing devices 106 and/or one or more remote computing devices 150 of FIGS. 1-2. Moreover, one or more portion(s) of the method 940 can be implemented as an algorithm on the hardware components of the device(s) described herein (e.g., as in FIGS. 1 and 2). FIG. 24 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At (942), the method 940 can include obtaining map data representative of a set of travel way portions within a given geographic area intended for vehicle navigation. Different geospatial file types can also be used for the map data obtained at (942), including but not limited to, SHL (Shapefile) file types, KMZ/KML (Keyhole Markup Language) file types, GDB (File Geodatabase) file types, MDB (Personal Geodatabase) file types, LYR (Layer) file types, OSM (OpenStreetMap) file types, and others.

At (944), the method 940 can include obtaining a set of coverage bounds (e.g., a set of one or more inclusion polygons and zero or more exclusion polygons) descriptive of those travel way portions to be included and optionally excluded in a coverage plan. Examples of a set of coverage bounds obtained at (944) are depicted in FIGS. 19-20.

At (946), the method 940 can include evaluating the map data obtained at (942) relative to the set of coverage bounds obtained at (944) to determine which travel way portions are required, permitted, and/or forbidden for vehicle navigation. For example, any travel way portion within the map data that is completely enclosed by an inclusion polygon can be permitted and required for inclusion within a coverage plan. Any travel way portion within the map data that is completely enclosed or partially touched by an exclusion polygon can be forbidden for inclusion within a coverage plan. Any travel way portion within the map data that is completely enclosed or partially touched by an optional exclusion polygon can be permitted but not required. When a given travel way or travel way portion is included in both an inclusion polygon and an exclusion polygon, predetermined rules can be created for analyzing the travel way portions to determine whether they should be determined to be required, permitted and/or forbidden travel way portions. In one example, when a travel way portion is part of both an inclusion polygon and an exclusion polygon, such travel way portion can be excluded. In other words, determination as an excluded travel way portion can trump determination as an included travel way portion.

At (948), the method 940 can include transforming map data including identified required (and optional permitted) travel way portions and connections between travel way portions into a coverage graph of nodes and edges. In some implementations, map data transformed at (948) can include travel way portions (e.g., roads, road segments, lanes, lane segments, parking lanes, turning lanes, bicycle lanes, and/or other portions of a particular travel way) and/or intersections and/or connections among adjacent travel way portions. One or more computing devices can then transform the map data at (948) into a coverage graph of nodes and edges. Each edge in the coverage graph determined at (948) can represent a travel way portion, while each node in the coverage graph can represent an intersection or connection among adjacent travel way portions. In some implementations, the coverage graph of nodes and edges transformed from map data at (948) can be configured to be strongly connected such that an edge is provided in both directions between each pair of connected nodes in the coverage graph. FIGS. 3-6 depict example aspects of transforming map data into a coverage graph as implemented at (948).

At (950), a coverage graph of nodes and edges resulting from the transforming of map data at (948) can be enhanced in one or more ways. For example, Eulerian balancing can be employed at (950) to generate additional artificial edges between unbalanced nodes that do not have an equal number of incoming edges and outgoing edges. In order to determine which nodes are unbalanced, an edge count can be determined at each node. The edge count can correspond to the number of incoming edges for a given node minus the number of outgoing edges for that node. A node characterized by a positive edge count corresponds to a node having one or more extra incoming edges, while a node characterized by a negative edge count corresponds to a node having one or more extra outgoing edges. For each node having a non-zero edge count (e.g., +1, −1, +2, −2, etc.), additional artificial edges can be generated between that node and another node having a non-zero edge count. In some implementations, additional artificial edges can be generated from a node having a positive edge count to a node having a negative edge count. If a node has N unbalanced edges, then N additional artificial edges can be added into or out of that node. An example of generating additional artificial edges between unbalanced nodes at (950) is depicted in FIGS. 7-8.

In some implementations, a matching algorithm can be employed to determine a preferred path for the additional artificial edges generated in the Eulerian balancing process at (950). In some examples, a bipartite matching algorithm can be employed, although other matching algorithms are also possible. A matching algorithm can be especially useful when a coverage graph contains more than one unique unbalanced node having a positive edge count and more than one unique unbalanced node having a negative edge count. An enhanced coverage graph can correspond to a coverage graph that is balanced using the described Eulerian balancing and/or bipartite matching enhancement algorithms. An example of generating additional artificial edges between unbalanced nodes at (950) using a matching algorithm to determine an optimal matching path is depicted in FIGS. 9-11.

Referring still to FIG. 19, method 940 can include at (952) a step of determining a coverage plan descriptive of a travel route along edges in a coverage graph determined at (948) and optionally enhanced at (950). For example, a travel route can be determined at (952) that traverses each edge in the coverage graph at least once while reducing total travel cost over all edges. In some implementations, the travel route can be determined at (952) by determining an Eulerian path among nodes and edges in a coverage graph. In some implementations, the Eulerian path traverses each edge in the coverage graph only once or as few times as possible.

In particular implementations, determining a coverage plan at (952) by determining an Eulerian path can include determining a main path as well as one or more sub-paths, if needed, which can be spliced into the main path. Determining a main path can include identifying a start node and traversing consecutive edges within the coverage graph from the identified start node until reaching the identified start node again. Nodes within the main path then can be checked to identify any remaining nodes having unvisited exits (e.g., outgoing edges not yet traversed as part of the main path). Each such identified remaining node can then form a subsequent starting node for a new sub-path from the remaining node along consecutive edges within the coverage graph not yet visited until returning to the remaining node. Upon completion of each sub-path, the sub-path can then be spliced into the main path between the remaining node and its original successor in the main path. The process of creating new sub-paths and splicing those sub-paths into the main path is repeated until all exits for all nodes within the coverage graph have been visited. An example of determining a travel route at (952) is depicted in FIG. 13.

At (954), the method 940 can include reducing turn angles within a determined path and resultant travel route. In particular, reducing turn angles at (954) can include preferring an outgoing edge from a given node that reduces the angle difference between an incoming edge and each outgoing edge, such as described relative to FIG. 12. In particular implementations, reducing turn angles can include selecting outgoing edges within a main path and/or sub-path that reduce turns (e.g., a total number of turns and/or a total value of angle difference associated with turns) within the path. For example, when a path follows an incoming edge and reaches a node having multiple outgoing edges, an outgoing edge can be selected that reduces the angle difference between the incoming edge and each outgoing edge. In some implementations, u-turns can be minimized by reducing selection of an outgoing edge that has an angle difference of 180 degrees from a corresponding incoming edge. In some implementations, outgoing edges that travel straight (e.g., have an angle difference as close to zero degrees as possible) relative to an incoming edge can be preferred over outgoing edges that turn (e.g., have a larger non-zero angle difference) relative to an incoming edge.

At (956)-(960), method 940 can include reducing turns within a travel route by removing any u-turns that may still exist within a travel route determined at (952). More particularly, a u-turn between a first node and a second node in a travel route can be identified at (956). An alternate path between the first node and the second node identified at (956) then can be determined at (958). The u-turn identified at (956) can then be replaced at (960) with the alternate path between the first node and the second node determined at (958). In some implementations, a u-turn can be replaced at (960) with an alternate path when a cost associated with the alternate path determined at (958) is below a given threshold and/or below a cost associated with the u-turn identified at (956). FIGS. 14-15 depict a first example of removing u-turns such as implemented at (956)-(960), while FIGS. 16-17 depict a second example of removing u-turns such as implemented at (956)-(960).

The technology discussed herein makes reference to computing devices, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer-implemented processes discussed herein can be implemented using a single computing device or multiple computing devices working in combination. Databases and applications can be implemented on a single system or distributed across multiple systems. Distributed components can operate sequentially or in parallel. Furthermore, computing tasks discussed herein as being performed at computing device(s) remote from the vehicle can instead be performed at the vehicle (e.g., via the vehicle computing system), or vice versa. Such configurations can be implemented without deviating from the scope of the present disclosure.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A vehicle computing system for implementing a coverage plan, comprising:
one or more processors on-board a vehicle; and
one or more memory devices on-board the vehicle, the one or more memory devices storing instructions that when executed by the one or more processors cause the computing system to perform operations, the operations comprising:
obtaining a coverage plan descriptive of a travel route for the vehicle to navigate a set of travel way portions within a map of a geographic area;
controlling the vehicle to navigate along the travel route described by the coverage plan;
gathering sensor data from one or more sensors provided with the vehicle as the vehicle is controlled to navigate the travel route; and
constructing a vehicle navigation map including travel way portions and intersections based at least in part on the sensor data gathered from the one or more sensors.

2. The vehicle computing system of claim 1, wherein the travel route described by the coverage plan includes all travel way portions in the set of travel way portions at least once while reducing total travel cost over all of the travel way portions.

3. The vehicle computing system of claim 1, wherein the operations further comprise generating the coverage plan.

4. The vehicle computing system of claim 3, wherein generating the coverage plan comprises:
transforming map data identifying the set of travel way portions into a coverage graph of nodes and edges, wherein each edge represents a travel way portion and each node represents an intersection or connection between adjacent travel way portions; and
determining the travel route as a route along edges in the coverage graph such that the travel route traverses each edge in the coverage graph at least once.

5. The vehicle computing system of claim 4, wherein generating the coverage plan further comprises generating additional artificial edges between unbalanced nodes that do not have an equal number of incoming edges and outgoing edges, wherein generating the additional artificial edges is implemented before determining the travel route.

6. The vehicle computing system of claim 4, wherein transforming map data identifying the set of travel way portions into a coverage graph of nodes and edges comprises transforming map data identifying the set of travel way portions into a strongly connected coverage graph of nodes and edges such that an edge is provided in both directions between each pair of connected nodes in the graph.

7. The vehicle computing system of claim 4, wherein generating the coverage plan further comprises reducing turn angles such that the travel route prefers an outgoing edge from a given node that reduces the angle difference between an incoming edge and each outgoing edge.

8. The vehicle computing system of claim 4, wherein generating the coverage plan further comprises:
identifying a u-turn between a first node and a second node in the travel route;
determining an alternate path between the first node and the second node; and
replacing the u-turn between the first node and the second node with the alternate path.

9. The vehicle computing system of claim 4, wherein generating the coverage plan further comprises:
obtaining map data representative of the set of travel way portions within a given geographic area intended for vehicle navigation;
obtaining a set of coverage bounds descriptive of one or more travel way portions to be included and zero or more travel way portions to be excluded; and
evaluating the map data relative to the set of coverage bounds to determine which travel way portions are required, permitted, or forbidden for vehicle navigation.

10. The vehicle computing system of claim 1, wherein the operations further comprise:
detecting a deviation of the vehicle from the travel route;
determining revised navigation instructions for returning the vehicle to a last unvisited permitted travel way portion within the travel route; and
controlling the vehicle according to the revised navigation instructions for returning the vehicle to the last unvisited permitted travel way portion within the travel route.

11. The vehicle computing system of claim 10, wherein the operations further comprise:
transmitting an update descriptive of a reason for the deviation of the vehicle from the travel route to another computing device remote from the vehicle.

12. The vehicle computing system of claim 1, wherein the operations further comprise:
controlling the vehicle to navigate along the travel route within the vehicle navigation map, the travel route including every travel way portion within the vehicle navigation map at least once and every turn at each intersection in the vehicle navigation map at least once.

13. A computer-implemented method of implementing a coverage plan, comprising:
transforming, by one or more computing devices, map data identifying travel way portions into a coverage graph of nodes and edges, wherein each edge represents a travel way portion and each node represents an intersection or connection between adjacent travel way portions;
determining, by the one or more computing devices, a coverage plan descriptive of a travel route along edges in the coverage graph, wherein the travel route traverses each edge in the coverage graph at least once while (i) reducing total travel cost over all edges, and (ii) reducing turn angles such that the travel route prefers an outgoing edge from a given node that reduces the angle difference between an incoming edge and each outgoing edge; and
controlling, by the one or more computing devices, a vehicle to navigate along the travel route described by the coverage plan.

14. The computer-implemented method of claim 13, further comprising:
gathering, by the one or more computing devices, sensor data from one or more sensors provided with the vehicle as the vehicle is controlled to navigate the travel route;
constructing, by the one or more computing devices, a vehicle navigation map including travel way portions and intersections based at least in part on the sensor data gathered from the one or more sensors; and
controlling, by the one or more computing devices, the vehicle to navigate along the travel route within the vehicle navigation map, the travel route including every travel way portion within the vehicle navigation map at least once and every turn at each intersection in the vehicle navigation map at least once.

15. The computer-implemented method of claim 13, further comprising:
identifying, by the one or more computing devices, a u-turn between a first node and a second node in the travel route;
determining, by the one or more computing devices, an alternate path between the first node and the second node; and
replacing, by the one or more computing devices, the u-turn between the first node and the second node with the alternate path.

16. The computer-implemented method of claim 13, further comprising:
generating, by the one or more computing devices, additional artificial edges in the coverage graph between unbalanced nodes that do not have an equal number of incoming edges and outgoing edges, wherein generating the additional artificial edges in the coverage graph is implemented before determining the coverage plan descriptive of the travel route.

17. The computer-implemented method of claim 13, wherein
transforming, by the one or more computing devices, the map data identifying the travel way portions into the coverage graph of nodes and edges comprises transforming, by the one or more computing devices, the map data identifying the travel way portions into a strongly connected coverage graph of nodes and edges such that an edge is provided in both directions between each pair of connected nodes in the coverage graph.

18. One or more tangible, non-transitory computer-readable media storing computer-readable instructions that when executed by one or more processors cause the one or more processors to perform operations, the operations comprising:
obtaining a coverage plan descriptive of a travel route for a vehicle to navigate a set of travel way portions within a map of a geographic area, wherein the travel route described by the coverage plan includes all travel way portions in the set of travel way portions at least once while reducing total travel cost over all of the travel way portions;
controlling the vehicle to navigate along the travel route described by the coverage plan; and
gathering sensor data from one or more sensors provided with the vehicle as the vehicle is controlled to navigate the travel route.

19. The one or more tangible, non-transitory computer-readable media of claim 18, wherein the operations further comprise:
constructing a vehicle navigation map based at least in part on the sensor data gathered from the one or more sensors, wherein the vehicle navigation map includes a plurality of travel way portions and intersections between adjacent travel way portions; and
controlling the vehicle to navigate along the travel route within the vehicle navigation map, the travel route including every travel way portion within the vehicle navigation map at least once and every turn at each intersection in the vehicle navigation map at least once.

20. The one or more tangible, non-transitory computer-readable media of claim 18, wherein the operations further comprise:
detecting a deviation of the vehicle from the travel route;
transmitting an update descriptive of a reason for the deviation of the vehicle from the travel route to another computing device remote from the vehicle;
determining revised navigation instructions for returning the vehicle to a last unvisited permitted travel way portion within the travel route; and
controlling the vehicle according to the revised navigation instructions for returning the vehicle to the last unvisited permitted travel way portion within the travel route.
